(19) United States
(12) Patent Application Publication
(10) Pub. No.: US 2010/0143724 A1
(43) Pub. Date: Jun. 10, 2010

(54) CORROSION RESISTANT METALLIZED FILMS AND METHODS OF MAKING THE SAME

(76) Inventor: Michael A. Johnson, Stillwater, MN (US)

Correspondence Address: 3M INNOVATIVE PROPERTIES COMPANY, PO BOX 33427, ST. PAUL, MN, 55133-3427, US

(21) Appl. No.: 11/909,219

(22) PCT Filed: Mar. 24, 2006
(86) PCT No.: PCT/US06/10751

§ 371 Date: Sep. 20, 2007

Related U.S. Application Data
(60) Provisional application No. 60/665,008, filed on Mar. 24, 2005.

(51) Int. Cl. B32B 15/04; B32B 15/095; B32B 15/09; B32B 15/082; B05D 1/36; B05D 3/06; B05D 3/08; B32B 38/00

(52) U.S. Cl. 428/424.4; 428/457; 428/425.8; 428/458; 428/424.8; 427/404; 427/535; 427/224; 156/278

(57) ABSTRACT

Corrosion resistant metallized films and methods of making the same are disclosed.

### FIELD OF THE INVENTION

The present invention relates to corrosion resistant metallized films and methods of making the same.

### BACKGROUND OF THE INVENTION

Metallized films are widely used to form three-dimensional decorative articles that can be attached to a variety of industrial and consumer items such as motorized vehicles, boats, furniture, building materials, appliances, and the like. These decorative articles can be substituted for their metal counterparts resulting in at least one of the following: lighter weight, lower manufacturing costs, better weather resistance, design flexibility, and sharper detail.

Corrosion of metallized films is an ongoing concern. Typically, metallized films are formed as sheet materials having an overall length, l, and an overall width, w. In some cases, the sheet material is subsequently slit to form tapes having a tape length, lₜ, and a tape width, w₁, wherein the total number of tapes, x, times the tape width, wₜ, substantially equals overall width, w. Outer edges along tape length, l, having an exposed portion of the metal layer of the metallized film are especially prone to corrode when exposed to the elements. Traditionally, the edges of metallized films constructed from corrosion susceptible metals have been encapsulated or overcoated with a protective coating to shield and protect the exposed, corrosion susceptible metal edge from the elements.

There exists a need in the art to enhance the corrosion resistance of metallized films, and especially metallized films constructed from corrosion susceptible metals having at least one edge that exposes a portion of a metal layer of the metallized film.

### SUMMARY OF THE INVENTION

The present invention is directed to corrosion resistant metallized films and methods of malting the same. In one exemplary embodiment, the metallized films comprise a primer layer, a metal layer over the primer layer, and a polymeric protective layer over the metal layer. The disclosed metallized films have enhanced corrosion resistance due to the construction and composition of the individual layers in the metallized films.

In one exemplary embodiment, the present invention is directed to a corrosion-resistant metallized film comprising a polymeric primer layer having a first surface; a metal layer on the first surface of the polymeric primer layer; and a polymeric protective layer on the metal layer, the protective layer having a second surface in contact with the metal layer; wherein the first and second surfaces (i) have a similar surface charge, and (ii) jointly impart corrosion resistance to the susceptible metal layer.

In a further exemplary embodiment, the present invention is directed to a corrosion-resistant metallized film comprising a polymeric primer layer comprising a first surface having an overall positive or negative surface charge; a metal layer on the first surface of the polymeric primer layer, the metal layer having a visually continuous appearance and a surface resistivity of at least about 10 ohms/cm²; and a polymeric protective layer on the metal layer, the protective layer comprising a second surface in contact with the metal layer, wherein the second surface has an overall surface charge similar to the first surface.

The present invention is also directed to methods of preparing a corrosion-resistant metallized film. In one exemplary embodiment, the method of forming a corrosion-resistant metallized film comprises the steps of providing a polymeric protective layer having a first surface with an overall positive or negative surface charge; depositing a metal layer on the first surface, the depositing step being terminated prior to or shortly after an onset of conductance within the metal layer; and applying a polymeric primer layer over the metal layer, the polymeric primer layer comprising a second surface in contact with the metal layer, wherein the second surface has an overall surface charge similar to the first surface of the polymeric protective layer.

The present invention is further directed to articles of manufacture comprising a corrosion-resistant metallized film. Exemplary articles of manufacture include, but are not limited to, corrosion-resistant metallized films, corrosion-resistant metallized films having an outermost adhesive layer, corrosion-resistant metallized films having an outermost pressure-sensitive adhesive layer temporarily protected by a release liner, corrosion-resistant metallized films adhered to a substrate, such as a thermoplastic or elastomeric substrate, thermoformable articles comprising a corrosion-resistant metallized film, and thermoformed articles comprising a corrosion-resistant metallized film.

These and other features and advantages of the present invention will become apparent after a review of the following detailed description of the disclosed embodiments and the appended claims.

### BRIEF DESCRIPTION OF THE DRAWINGS

The above aspects may be more completely understood in consideration of the following detailed description of various embodiments in connection with the accompanying drawings, in which:

FIG. 1 is a cross-sectional view of an exemplary corrosion-resistant metallized film of the present invention;

FIG. 2 is a perspective view of the individual layers in the exemplary corrosion-resistant metallized film of FIG. 1;

FIG. 3A is a perspective view of an exemplary metal layer suitable for use in an exemplary corrosion-resistant metallized film of the present invention;

FIG. 3B is a perspective view of another exemplary metal layer suitable for use in an exemplary corrosion-resistant metallized film of the present invention;

FIG. 3C is a perspective view of an exemplary metal layer suitable for use in an exemplary corrosion-resistant metallized film of the present invention, wherein the exemplary metal layer comprises a discontinuous pattern having at least two separate metal areas;

FIG. 4A is a perspective view of an upper surface of an exemplary metal area suitable for use in a metal layer of a corrosion-resistant metallized film of the present invention, wherein the exemplary metal area comprises a visually continuous, but conductively discontinuous metal area;

FIG. 4B is a cross-sectional view of the exemplary metal area of FIG. 4A;

FIG. 5 is a cross-sectional view of an exemplary article comprising a corrosion-resistant metallized film of the present invention; and

FIG. 6 is a cross-sectional view of an exemplary article comprising a corrosion-resistant metallized film adhered to a substrate;

FIG. 7A is a perspective view of an exemplary mold used in a thermoforming step in Example 42 and Reference Example R1;

FIG. 7B is a side view of the exemplary mold shown in FIG. 7A as viewed in the direction of arrow A shown in FIG. 7A; and

FIG. 8 is a graph showing a plot of specularity versus wavelength for film samples of Example 42 and Reference Example R1.

While the invention is amenable to various modifications and alternative forms, specifics thereof have been shown by way of example in the drawings will be described in detail. It should be understood, however, that the intention is not to limit the invention to the particular embodiments described. To the contrary, the intention is to cover all modifications, equivalents, and alternatives falling within the spirit and scope of the present disclosure.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the present invention is intended by the use of specific language. Alterations, further modifications, and such further applications of the principles of the present invention discussed are contemplated as would normally occur to one ordinarily skilled in the art to which the invention pertains.

The present invention is directed to corrosion-resistant metallized films and methods of making corrosion-resistant metallized films. The present invention is further directed to articles of manufacture that include a corrosion-resistant metallized film, as well as methods of making articles of manufacture that include a corrosion-resistant metallized film.

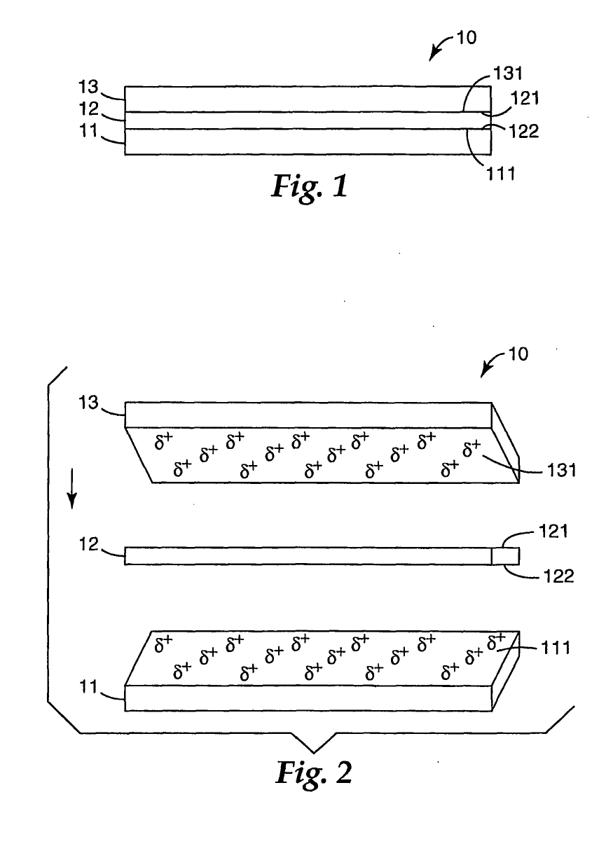

An exemplary corrosion-resistant metallized film of the present invention is provided in FIG. 1. As shown in FIG. 1, exemplary corrosion-resistant metallized film 10 comprises polymeric primer layer 11, metal layer 12, and polymeric protective layer 13. In this exemplary embodiment, outer surfaces 121 and 122 of metal layer 12 are in direct contact with outer surface 131 of polymeric protective layer 13 and outer surface 111 of polymeric primer layer 11 respectively.

It has been discovered that the corrosion resistance of a given metallized film may be enhanced by selectively controlling one or more film construction parameters, each of which separately impacts the corrosion behavior of a given metallized film. Film construction parameters of particular interest in the present invention include (i) the surface structure, functionality, and surface charge of each of the surface layers adjacent the metal layer of the metallized film (e.g., the surface structure, charge and functionality of outer surface 131 of polymeric protective layer 13 and outer surface 111 of polymeric primer layer 11), (ii) the hydrogen ion transport potential through or across the metal layer of the metallized film, and (iii) the surface resistivity and/or optical density of the metal layer within the metallized film.

For example, it has been discovered that the corrosion resistance of a given metallized film may be improved by maintaining a similar surface functionality or surface polarity (also referred to herein as a similar surface charge) on each side of the metal layer. As used herein, the term “similar surface charge” refers to surfaces next to the metal layer, wherein each surface has either an overall positive or negative surface so as to minimize the hydrogen ion (H⁺) transport potential across a metal layer positioned between the two surfaces. As described below, a “similar surface charge” may be the result of (i) a polymeric material within a given layer, wherein the polymeric material has positive or negative functional groups thereon; (ii) functionalized additives within a given layer, wherein the functionalized additives have a positive or negative charge; (iii) a surface treatment of a given layer surface, wherein the surface treatment results in a positive or negative charge; or (iv) any combination of (i) to (iii).

An exemplary corrosion-resistant metallized film of the present invention, which possesses this corrosion-enhancing film construction parameter, is illustrated in FIG. 2. As shown in FIG. 2, each of outer surface 131 of polymeric protective layer 13 and outer surface 111 of polymeric primer layer 11 has a positive surface charge or surface polarity on either side of metal layer 12. Although not shown, it should be understood that a similar degree of corrosion resistance would be expected if each outer surface 131 of polymeric protective layer 13 and outer surface 111 of polymeric primer layer 11 had a negative surface charge or surface polarity on either side of metal layer 12. As explained below, one or more techniques may be used to provide a particular surface charge or surface polarity to a given surface.

As illustrated in FIGS. 1 and 2, corrosion-resistant metallized films of the present invention may comprise a number of individual layers, as well as possess one or more film construction parameters that impact the corrosion resistance of the metallized films. A description of the individual layers, the overall construction, and various film construction parameters of exemplary corrosion-resistant metallized films of the present invention are provided below.

### I. Corrosion-Resistant Metallized Films

The corrosion-resistant metallized films of the present invention have a unique film structure, which results in enhanced corrosion resistance. As discussed above, one or more film construction parameters may be tailored to enhance the corrosion resistance of a given film construction. A description of each layer of the metallized films of the present invention, as well as film construction parameters for optimizing the corrosion resistance of the resulting metallized film is provided below.

A. Corrosion-Resistant Metallized Film Layers

The corrosion-resistant metallized films of the present invention comprise at least the following individual layers.

1. Polymeric Protective Layer

The corrosion-resistant metallized films of the present invention comprise at least one polymeric protective layer, such as exemplary polymeric protective layer 13 of exemplary corrosion-resistant metallized film 10. The polymeric protective layer covers an adjacent metal layer, providing one or more of the following properties to the resulting metallized film: scratch resistance, impact resistance, water resistance, weather resistance, solvent resistance, resistance to oxidation, and resistance to degradation by ultraviolet radiation. In most embodiments, the polymeric protective layer completely covers the adjacent metal layer such that no portion of the metal layer is exposed.

The polymeric protective layer may comprise one or more polymeric components. Suitable polymeric components include, but are not limited to, polyurethanes, polymers or copolymers containing polar groups thereon, polyolefins, ethylene/vinyl acetate/acid terpolymers, acrylate-based materials, acid or hydroxyl-functional polyesters, ionomers, fluoropolymers, fluoropolymer/acrylate blends, polymers doped with one or more additives containing acidic or basic functional groups, or any combination thereof. In one desired embodiment of the present invention, the polymeric protective layer comprises one or more polymeric components, wherein at least one polymeric component has functional groups thereon resulting in an overall surface charge or surface polarity for at least an outer surface of the polymeric protective layer adjacent a metal layer (e.g., outer surface 131 of polymeric protective layer 13 shown in FIGS. 1-2). In this embodiment, the polymeric component having functional groups thereon may comprise, for example, a water-borne polyurethane, a solvent-based polyurethane, a polymer or copolymer prepared from acidic monomers (e.g., an ethylene acrylic acid (EAA) copolymer), or a polymer or copolymer prepared from basic monomers (e.g., polyamides, or polyacrylamide copolymers).

The polymeric protective layer may further comprise one or more additives incorporated into the one or more polymeric components of the polymeric protective layer. Suitable additives include, but not limited to, functionalized additives, non-functionalized additives, or a combination thereof. As used herein, the term “functionalized additives” is used to describe additives having functional groups thereon such that the additive is capable of providing and/or contributing to an overall surface charge or surface polarity for at least an outer surface of the polymeric protective layer adjacent a metal layer (e.g., outer surface 131 of polymeric protective layer 13 shown in FIGS. 1-2). Suitable functionalized additives include, but are not limited to, (i) additives having thereon an acidic functional group, which is capable of donating a hydrogen ion such as sulfonic acids, phosphoric acids, phosphonic acids, boric acids, carboxylic acids, mercapto groups, salts of these acids, esters of these acids, or combinations thereof, and (ii) additives having thereon a basic functional group such as, amine groups, phosphorous compounds such as triphenyl phosphite, alkoxy groups, nitrile groups, heterocyclic moieties such as those described in U.S. Pat. No. 5,081,213, and the like. Exemplary functionalized additives include, but are not limited to, heterocyclic compounds such as benzotriazoles, oxygen or sulfur containing compounds such as mercaptopropyl trimethoxysilane and mercapto acetic acid. Ideally, the functionalized additive is capable of interacting chemically with the metal so that a chemical interaction or chemical bond can be established directly between the functionalized additive and the metal. This ability to react with the metal enables a diffuse interface between the organic polymeric protective layer and inorganic metal layer, which aids in bridging the dissimilarity between the two layers.

As used herein, the term “non-functionalized additives” is used to describe additives that provide a minimal contribution to an overall surface charge or surface polarity to the polymeric protective layer. Suitable non-functionalized additives include, but are not limited to, most dyes, most pigments, wetting agents such as surfactants, inert filler materials (e.g., glass microspheres, silica, calcium carbonate), waxes and slip agents, and some UV stabilizers.

When present, the functionalized additives, non-functionalized additives, and any combination thereof may represent up to about 50 percent by weight (pbw) based on a totals weight of the polymeric protective layer, with the balance being one or more polymeric materials. Typically, when present, each individual functionalized additive or non-functionalized additive is present in an amount ranging from greater than about 0.05 pbw to about 20 pbw, preferably between about 0.1 and about 10 pbw, and most preferably between about 0.5 and about 5 pbw, based on a totals weight of the polymeric protective layer, with the balance being one or more polymeric materials.

The polymeric protective layer may also have one or more surface treatments to alter outer surface properties of the polymeric protective layer, especially the outer surface of the polymeric protective layer adjacent the metal layer (e.g., outer layer 131 of polymeric protective layer 13 shown in FIGS. 1-2). Any surface treatment capable of chemically grafting functional groups or oxidizing the surface of the polymeric protective layer is acceptable so long as no macroscopic degradation occurs within or on the surface of the polymeric protective layer. Suitable surface treatments include, but are not limited to, a corona discharge surface treatment, flame treatment, and glow discharge surface treatments. In one exemplary embodiment, the one or more surface treatments enhances the surface charge capacity or surface polarity of the outer surface of the polymeric protective layer adjacent the metal layer. For example, a glow discharge surface treatment may be used to increase the amount of oxygen covalently bonded to an outer surface of the polymeric protective layer adjacent the metal layer.

In one exemplary embodiment of the present invention, the polymeric protective layer comprises one or more polymeric materials alone or in combination with one or more additives, wherein at least one of the polymeric materials or additives has acidic or basic functional groups thereon. In a further exemplary embodiment, the polymeric protective layer comprises one or more polymeric materials alone or in combination with one or more additives, wherein (i) at least one of the polymeric materials or additives has acidic functional groups, (ii) at least one of the polymeric materials or additives has basic functional groups, (iii) the outer surface of the polymeric protective layer adjacent the metal layer has a corona discharge or glow discharge surface treatment, (iv) both (i) and (iii), or (v) both (ii) and (iii).

In one exemplary embodiment, the polymeric protective layer comprises an aliphatic water-borne polyurethane resin such as those described in U.S. Pat. No. 6,071,621. Commercially available aliphatic waterborne polyurethanes include, but are not limited to, materials sold under the trade designation “NEOREZ” (e.g., NEOREZ SR 9699, XR 9679, and XR 9603) from Avecia (Waalwijk in The Netherlands), and materials sold under the trade designation “BAYHYDROL” (e.g., BAYHYDROL 121) from Bayer Corp. (Pittsburgh, Pa.). Alternative polymer dispersion resins include polyurethane and polyurethane acrylate dispersions sold under the trade designation “ALBERDINGK” (e.g., ALBERDINGK U933) from Alberdingk Boley Inc. (Charlotte, N.C.). The polyurethane protective layer may be cross-linked by adding cross-linking materials such as aziridine compounds in the dispersion or by cross-linking after the film has been formed using such means as radiation, e.g., UV light, or heat.

In a further exemplary embodiment, the polymeric protective layer comprises a solvent-based polyurethane resin formed by the reaction of one or more polyols with a polyisocyanate. In some applications, it is desirable for the polyols and the polyisocyanates to be free of aromatic groups. Suitable polyols include, but are not limited to, materials commercially available under the trade designation “DESMOPHEN” from Bayer Corporation (Pittsburgh, Pa.). The polyols can be polyester polyols (e.g., DESMOPHEN 631A, 650A, 651A, 670A, 680, 110, and 1150); polyether polyols (e.g., DESMOPHEN 550U, 1600U, 1900U, and 1950U); or acrylic polyols (e.g., DEMOPHEN Al60SN, A575, and A450BA/A). The use of polyisocyanate compounds, compounds having more than two isocyanate groups, can result in the formation of cross-linked polyurethanes. Suitable polyisocyanate compounds include, but are not limited to, materials commercially available under the trade designation “MONDUR” and “DESMODUR” (e.g., DESMODUR XP7100 and DESMODUR 3300) from Bayer Corporation (Pittsburgh, Pa.).

In yet a further exemplary embodiment, the polymeric protective layer comprises a polymer or copolymer containing (i) at least one polar group along the polymer chain, (ii) at least one olefinic portion, or (ii) both (i) and (ii). In some embodiments, the polar groups are acids groups, esters thereof, or salts thereof. For example, the polar groups are carboxylic acids, carboxylate esters, or carboxylate salts. Suitable carboxylic acids, carboxylate esters, and carboxylate salts include, but are not limited to, acrylic acid, C₁ to C₂₀ acrylate esters, acrylate salts, (meth)acrylic acid, C₁ to C₂₀ (meth)acrylate esters, (meth)acrylate salts, or combinations thereof. Suitable methacrylate and acrylate esters typically contain up to about 20 carbon atoms or up to about 12 carbon atoms (excluding the acrylate and methacrylate portion of the molecules). In some embodiments, the methacrylate and acrylate esters contain about 4 to about 12 carbon atoms.

The olefinic portion of the polymer or copolymer can be formed by free radical polymerization of monomers such as, for example, ethylene, propylene, isobutylene, or combinations thereof. In some embodiments, the olefinic materials include an olefinic monomer having ethylenic unsaturation. For example, reacting a polyethylene oligomer or ethylene monomers with a monomer having a polar group can form a copolymer for use in the polymeric protective layer.

In some embodiments, the copolymer is a reaction product of an olefinic monomer having ethylenic unsaturation with a second monomer selected from (meth)acrylic acid, a C₁ to C₂₀ (meth)acrylate ester, a (meth)acrylate salt, acrylic acid, a C₁ to C₂₀ acrylate ester, an acrylate salt, or a combination thereof. The copolymer can be prepared using about 80 to about 99 weight percent of the olefinic monomer and about 1 to about 20 weight percent or the second monomer. For example, the copolymer can be prepared by copolymerizing about 83 to about 97 weight percent of the olefinic monomer and about 3 to about 17 weight percent acrylic acid, a C₁ to C₂₀ acrylate ester, an acrylate salt, (meth)acrylic acid, a C₁ to C₂₀ (meth)acrylate ester, a (meth)acrylate salt, or combinations thereof. In another example, the copolymer contains from about 90 to about 96 weight percent of the olefinic monomer and about 4 to about 10 weight percent acrylic acid, a C₁ to C₂₀ acrylate ester, an acrylate salt, (meth)acrylic acid, a C₁ to C₂₀ (meth)acrylate ester, a (meth)acrylate salt, or combinations thereof.

When salts of a (meth)acrylate or acrylate group are present in the polymer or copolymer, the positive ion of the salt is typically an alkali metal ion, an alkaline earth metal ion, or a transition metal ion. For example, the positive ion can include, for example, sodium, potassium, calcium, magnesium, or zinc.

In some embodiments, the polymeric protective layer includes a copolymer such as, for example, ethylene (meth)acrylic acid or ethylene acrylic acid. Commercially available copolymers suitable for use in the polymeric protective layer include, but are not limited to, copolymers available from Dow Chemical Company (Midland, Mich.) under the trade designation “PRIMACOR” such as PRIMACOR 3330, which has 6.5% acrylic acid and 93.5% ethylene; copolymers commercially available from DuPont (Wilmington, Del.) under the trade designation “NUCREL” such as NUCREL 0403 (a copolymer of ethylene and methacrylic acid); copolymers commercially available under the trade designation “ELVALOY” (copolymers of ethylene with butyl acrylate, ethyl acrylate, or methyl acrylate); and copolymers commercially available under the trade designation “SURLYN” (ionomer of ethylene and acrylic acid).

The one or more polymeric materials used to form the polymeric protective layer may be cross-linked if desired. For example, the above-described water-borne polyurethane compositions can be cross-linked by the addition of a cross-linking agent (e.g., less than about 3 weight percent) such as diaziridine. A commercially available diaziridine is sold under the trade designation “NEOCRYL” (e.g., NEOCRYL CX-100) from Avecia (Waalwijk in the Netherlands). The above-described solvent-based polyurethane resin may be cross-linked, for example, by reaction with a cross-linking or curing agent such as a melamine resin. Further, the above-described polymers or copolymers containing (i) at least one polar group along the polymer chain, (ii) at least one olefinic portion, or (iii) both (i) and (ii), may be cross-linked, for example, using electron beam radiation.

The polymeric protective layer can have a high or low gloss surface, as desired. Additionally, the polymeric protective layer can have high or low reflectivity, as desired. The polymeric protective layer is desirably transparent to visible radiation so that the underlying metal layer is visible though the polymeric protective layer. As used herein, the term “transparent” refers to materials that allow at least about 50 percent of visible radiation to pass through the materials. For example, the transparent material can pass at least about 75 percent, at least about 80 percent, at least about 85 percent, at least about 90 percent, or at least about 95 percent of visible radiation. In some applications, the polymeric protective layer is colored yet transparent. For example, the polymeric protective layer may contain dyes and/or pigments in order to provide a color to the polymeric protective layer.

The polymeric protective layer may be provided as a preformed layer such as a self-supporting film or may be cast from a solution onto a release liner. For example, when the polymeric protective layer is an aliphatic water-borne polyurethane resin, the aqueous urethane dispersion can be cast onto a release liner such as a bare or release coated polyester film. The cast urethane dispersion can then be dried to remove water. In another example, solvent-containing mixture of a polyisocyanate and a polyol can be cast onto a release liner. The cast mixture can then be dried to remove any solvent.

When the polymeric protective layer is formed on a release liner, the release liner may be used to provide topographical features to the outer surface of the polymeric protective layer. For example, the release liner may provide a uniform pattern of valleys and/or ridges along the outer surface of the polymeric protective layer. Alternatively, the release liner may have a randomly textured pattern to provide a matte surface to the surface. In other embodiments, the release liner may be used to provide the outer surface of the polymeric protective layer with a substantially smooth surface. Release liners suitable for use in the present invention include, but are not limited to, release liners disclosed in U.S. Published Patent Application Nos. 20040048024 and 20030129343 (now, U.S. Pat. No. 6,984,427), the disclosures of which are incorporated herein by reference in their entirety.

In other embodiments of the present invention, an outer surface of the polymeric protective layer, especially the outer surface opposite the metal layer, may be embossed to provide a pattern in the outer surface prior to or after joining the polymeric protective layer with a metal layer. Embossing methods suitable for use in the present invention include, but are not limited to, embossing methods disclosed in U.S. Pat. No. 5,897,930, the disclosure of which is incorporated herein in its entirety.

In some embodiments of the present invention, the outer surface of the polymeric protective layer adjacent the metal layer may be a substantially flat, smooth, planar surface having very little, if any, topographical features thereon. As used herein, the term “planar” is used to describe a surface of a layer that is substantially within the same plane. In these embodiments, a subsequently applied metal layer may provide the metallized film with a mirror-like appearance. In other embodiments of the present invention, the outer surface of the polymeric protective layer adjacent the metal layer may have a non-planar surface, such as a surface having topographical features thereon. As described above, an embossing technique may be used to provide the outer surface of the polymeric protective layer adjacent the metal layer with topographical features. Other techniques may include, but are not limited to, the use of another release liner having topographical features therein to form the outer surface of the polymeric protective layer adjacent the metal layer. In these embodiments, a subsequently applied metal layer may provide the metallized film with an alternative appearance.

The polymeric protective layer typically has an average thickness of at least about 5 micrometers (μm) although the polymeric protective layer may have any desired thickness. In some applications, the polymeric protective layer has a thickness of at least about 10 μm, at least about 15 μm, at least about 20 μm, or at least about 25 μm. The thickness of the polymeric protective layer is usually less than about 50 μm although there is no limitation on the thickness of the polymeric protective layer. In some applications, the polymeric protective layer has a thickness less than about 40 μm, less than about 35 μm, or less than about 30 μm. For example, the thickness can be in the range of about 5 to about 50 μm, or about 10 to about 40 μm, or about 20 to about 30 μm.

2. Metal Layer

The corrosion-resistant metallized films of the present invention further comprise a metal layer, such as exemplary metal layer 12 of exemplary corrosion-resistant metallized film 10. The metal layer may be opaque, reflective or non-reflective. In some embodiments, the metal layer provides a polished, mirror-like finish. Further, the metal layer may form a continuous or discontinuous pattern of metallic material between the polymeric protective layer and the polymeric primer layer.

The metal layer can be selected from a wide range of metal-containing materials such as, for example, metals, alloys, and intermetallic compositions. The metal layer can include tin, gold, silver, aluminum, indium, nickel, iron, manganese, vanadium, cobalt, zinc, chromium, copper, titanium, and combinations thereof. Examples of combinations include, but are not limited to, stainless steel and INCONEL® alloys.

The metal layer is usually formed by deposition of metal onto the above-described polymeric protective layer. The metal can be deposited using any known technique. For example, suitable deposition methods include, but are not limited to, sputtering, electroplating, ion sputtering, or vacuum deposition. In some applications, the metal is deposited using vacuum deposition methods. Suitable metal deposition methods for use in the present invention include, but are not limited to, metal deposition methods disclosed in Foundations of Vacuum Coating Technology by D. M. Mattox, published by William Andrew/Noyes (2003).

The thickness of the metal layer can vary as needed to provide a desired surface appearance. Desirably, the metal layer has a thickness that does not negatively impact the surface functionality of the outer surfaces of the above-described polymeric protective layer and the polymeric primer layer (described below) that come into contact with the metal layer.

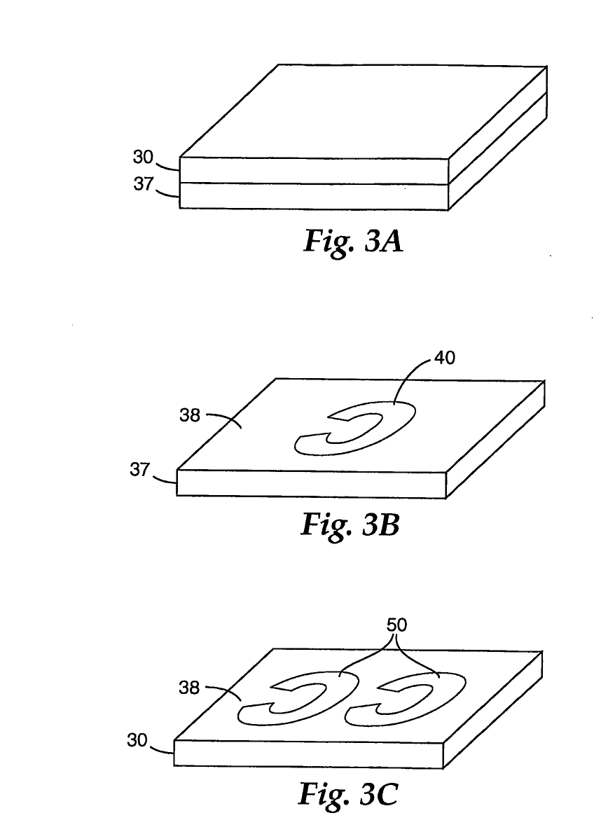

As discussed above, the metal layer may comprise a continuous pattern (e.g., a metal layer comprising a single area of metallic material) that substantially covers an outer surface of the polymeric polymer layer. An example of this embodiment is shown in FIG. 3A, wherein exemplary metal area 30 completely covers exemplary polymeric polymer layer 37 and comprises a single continuous pattern of metallic material that forms a single area of metal. In another embodiment shown in FIG. 3B, a single continuous area of metallic material 40 may be used to form a pattern such as the letter “C” on an outer surface 38 of the polymeric polymer layer 37. In a further embodiment of the present invention, the metal layer may comprise a discontinuous pattern having two or more disconnected areas of metallic material on an outer surface of the polymeric polymer layer such as in the exemplary embodiment shown in FIG. 3C. As shown in FIG. 3C, two disconnected areas of metallic material 50 may be used to form a discontinuous pattern comprising two separate letters “C C” on an outer surface 38 of the polymeric polymer layer 37.

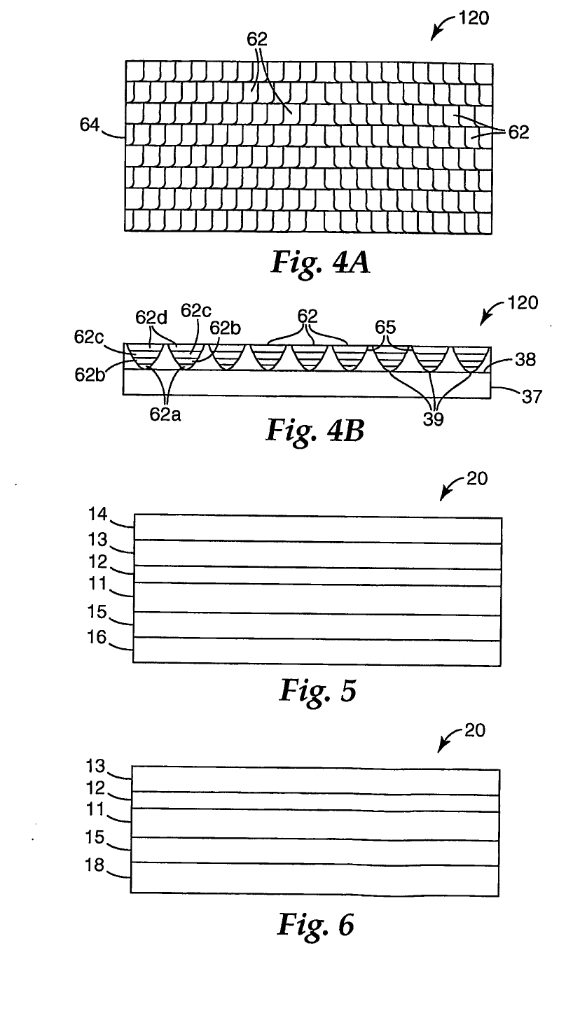

Regardless of whether the metal layer comprises a continuous pattern or a discontinuous pattern, each area of metallic material (e.g., each of exemplary metal areas 30, 40 and 50) may comprise a plurality of individual metal areas positioned adjacent to one another to form a resulting metal area, such as exemplary metal area 120 as shown in FIG. 4A. It has been discovered that, in some embodiments, enhanced corrosion resistance of a metallized film may be obtained by incorporating a metal layer containing one or more metal areas, such as exemplary metal area 120, into the metallized film. As shown in FIG. 4A, exemplary metal area 120 comprises a plurality of discontinuous metal areas 62, which form a pattern of metallic material 64. In this embodiment, although metal area 120 appears to be visually continuous, metal area 120 is discontinuous in terms of surface conductivity or resistivity.

The discontinuity of exemplary metal area 120 results in a metal layer having a surface resistivity of at least about 2 ohms/cm², desirably, at least about 10 ohms/cm². In one exemplary embodiment, the metal area has a surface resistivity of at least about 3, at least about 5, at least about 10, or at least about 20 ohms/cm². In some embodiments, it is desirable for performance reasons to have as high a surface resistivity as possible while maintaining as high of an optical density that would satisfy the visual aesthetic requirements of the application.

It is believed that the discontinuity of a metal layer, such as a metal layer containing one or more areas similar to exemplary metal area 120, enables increased interaction between (i) surface functional or polar groups along an outer surface of the polymeric protective layer and (ii) surface functional or polar groups along an outer surface of the polymeric primer layer described below. Further, it is believed that the discontinuity of the metal layer enables hydrogen ion (H⁺) transport across the metal layer. Therefore, if a charge potential or hydrogen ion (H⁺) transport potential exists across the metal layer (i.e., one outer surface has a positive surface functional groups or polar groups, and the other outer surface has negative surface functional groups or polar groups), hydrogen ion (H⁺) transport will occur, increasing the likelihood of corrosion of the metal layer. Consequently, in some embodiments, the metallized films of the present invention comprise a metal layer having one or more areas similar to exemplary metal area 120 sandwiched between outer surfaces of a polymeric protective layer and a polymeric primer layer, wherein both of the outer surfaces have similarly charged surface functional or polar groups thereon (e.g., both surfaces have positive surface functional groups or positive polar groups thereon or therein, or both surfaces have negative surface functional groups or negative polar groups thereon or therein) in order to minimize the hydrogen ion (H⁺) transport potential across the metal layer.

One method of forming a metal area comprising a plurality of individual, adjacent metal area, such as exemplary metal area 120, comprises a metal deposition step, wherein the deposition step is terminated prior to or shortly after an onset of conductance within the metal area. Such a deposition step is illustrated in FIG. 4B, which depicts a cross-sectional view of exemplary metal area 120 shown in FIG. 4A. As shown in FIG. 4B, a plurality of discontinuous metal areas 62 extend upward from outer surface 38 of polymeric polymer layer 37. It is believed that, during a metal deposition procedure, each individual metal area 62 is assembled in a step-wise process, wherein a base metal deposit, such as exemplary base metal deposit 62A, first attaches to outer surface 38 of polymeric polymer layer 37 at locations 39 along outer surface 38. Locations 39 may correspond to (i) a functional group on a polymeric material used in polymeric polymer layer 37, (ii) a functional group on an additive used in polymeric polymer layer 37, (iii) a surface treatment site resulting from one or more of the above-described surface treatments, or any combination of (i), (ii) and (iii). As shown in FIG. 4B, exemplary base metal deposit 62A are spaced apart from one another along outer surface 38 of polymeric polymer layer 37. As additional metal is deposited, one or more intermediate metal deposits, such as exemplary intermediate metal deposits 62B and 62C, result in individual metal areas 62 having an increased height (extending from outer surface 38) and a decrease in spacing between individual metal areas 62. At some point during the deposition step, if the metal deposition step is allowed to continue, individual metal areas 62 will merge with one another, forming a continuous metal area that is all electrically interconnected. Desirably, in some embodiments of the present invention, the metal deposition step is stopped such that outer peripheries of adjacent individual metal areas 62 have space therebetween such as shown in FIG. 4B. The primary driving force for the behavior of the metal during deposition is the high surface energy nature of the metal in relation to that of the organic-based polymeric layer. The relative surface energy difference does not enable a favorable interaction or wetting to occur between the metal and the polymeric layer thereby causing the metal initially to be deposited into discrete microscopic domains. It is believed that prior to reaching the point of electrical interconnectivity, the available surface area of metal, compared to the actual volume of metal in the coating is at or near a maximum and provides for a great amount of surface interaction between the metal coating and the polymeric protective and polymeric primer layers. It is believed that this enhanced amount of surface interaction is responsible for a greater amount of chemical interaction and stabilization at either metal surface.

As shown in FIG. 4B, outer peripheries 65 of uppermost metal deposits 62D of individual metal areas 62 are positioned close to one another, but desirably have spacing therebetween. In some embodiments, outer peripheries 65 of uppermost metal deposits 62D of individual metal areas 62 may come into contact with one another and still result in a metal area having a discontinuous conductivity. As used herein, the term “discontinuous conductivity” is used to describe a metal area or metal layer typically having a surface conductivity of less than about 0.1 mhos or a surface resistivity of at least about 10 ohms/cm², although this can vary depending on the metal used.

If a metal deposition step is allowed to continue and the resulting metal layer is too thick, in some embodiments, the positive effects of having similarly charged outer surfaces of adjacent polymeric layers (i.e., the polymeric protective layer and the polymeric primer layer) appears to be overcome and corrosion resistance of the metal layer is hampered. If the metal layer becomes too thick, the surface resistivity drops. If the surface resistivity drops to a level approaching about 1.0 ohm/cm², the positive effects of the adjacent polymeric layers disappears. It is believed that as more metal is deposited and the surface resistivity value of about 1.0 ohm/cm² is approached, an excess of pure, unoxidized metal becomes available within the metal coating itself. This ‘pure’ metal is susceptible to corrosion and should oxidation start, the self-catalyzing behavior of corrosion overwhelms the positive effects of the adjacent polymeric layers, resulting in deterioration (i.e., corrosion) of the metal layer.

While not wishing to be bound by theory, it is believed that initial deposits of inorganic metal material are partially oxidized upon contact with the organic polymeric protective layer thereby creating a partial or half-oxide metal oxide coating. It is believed that this partial oxidation of the metal coating is at least partially responsible for the outstanding corrosion resistant characteristics of the metallized film without a loss of opacity in the metal coating. Further deposits of inorganic metal material do not undergo this partial oxidation resulting in metal coating (as oppose to metal oxide coating).

Typically, the amount of metal deposited on a given surface may be measured by the optical density of the metal layer, which is a measure of transmission and is obtained by taking the negative log of transmission. Although the optical density will vary with the metal being deposited, typically, the metal layer has an optical density of less than about 2.0. For example, aluminum may have a desirable optical density lower than about 2.0, while tin may have a desirable optical density between about 2.0 and about 2.2.

3. Polymeric Primer Layer

The corrosion-resistant metallized films of the present invention also comprise at least one polymeric primer layer, such as exemplary polymeric primer layer 11 of exemplary corrosion-resistant metallized film 10. The polymeric primer layer covers an outer surface of the metal layer opposite the above-described polymeric protective layer as shown in exemplary corrosion-resistant metallized film 10 of FIG. 1. Like the polymeric protective layer, the polymeric primer layer provides the metal layer with one or more properties: scratch resistance, impact resistance, water resistance, weather resistance, solvent resistance, resistance to oxidation, and resistance to degradation by ultraviolet radiation. In most embodiments, the polymeric primer layer completely covers an outer surface of the metal layer opposite the above-described polymeric protective layer such that no portion of the metal layer is exposed.

The polymeric primer layer may comprise one or more of the above-described polymeric components and optional additives suitable for use in the polymeric protective layer. Further, one or more outer surfaces of the polymeric primer layer may have one or more of the above-described surface treatments to alter an outer surface of the polymeric primer layer. In one exemplary embodiment, the outer surface of the polymeric primer layer adjacent the metal layer (e.g., outer layer 111 of polymeric primer layer 11 shown in FIG. 1) is surface treated using one of the above-described surface treatments.

In one desired embodiment of the present invention, the polymeric primer layer comprises one or more polymeric materials alone or in combination with one or more additives, wherein at least one of the polymers or additives has acidic or basic functional groups thereon. In a further desired embodiment, the polymeric primer layer comprises one or more polymeric materials alone or in combination with one or more additives, wherein (i) at least one of the polymers or additives has acidic functional groups, (ii) at least one of the polymers or additives has basic functional groups, (iii) the outer surface of the polymeric primer layer adjacent the metal layer has a corona discharge or glow discharge surface treatment, (iv) both (i) and (iii), or (v) both (ii) and (iii).

In a further embodiment of the present invention, the polymeric primer layer comprises one or more thermoplastic polymeric materials so as to provide the polymeric primer layer with an outer adhesive surface opposite the metal layer. The outer adhesive surface of the polymeric primer layer can be tacky at room temperature (e.g., pressure-sensitive) or after application of heat (e.g., heat-activatable). Thermoplastic polymers suitable for use in the polymeric primer layer for providing an outer adhesive surface include, but are not limited to, polyolefins, polyurethanes, nylon, acrylics, and combinations thereof.

Suitable pressure-sensitive adhesives and heat-activatable adhesives for use in the polymeric primer layer include, but are not limited to, adhesives disclosed in U.S. Pat. No. RE024906 and EP 0384598, the disclosures of which are incorporated herein by reference in their entirety. In addition, the outer adhesive surface of the polymeric primer layer opposite the metal layer may include a surface topography to provide air-bleed capabilities to the polymeric primer layer, provide repositionability, or both.

Like the polymeric materials used to form the polymeric protective layer, the one or more polymeric materials used to form the polymeric primer layer may be cross-linked if desired. Suitable cross-linking methods include those described above with regard to the polymeric protective layer.

The polymeric primer layer may be transparent to visible radiation so that the metal layer is visible though the polymeric primer layer, i.e., the polymeric primer layer allows at least about 50 percent of visible radiation to pass through the polymeric primer layer. For example, in some embodiments, the polymeric primer layer allows at least about 75 percent, at least about 80 percent, at least about 85 percent, at least about 90 percent, or at least about 95 percent of visible radiation therethrough. In some applications, the polymeric primer layer is colored yet transparent. For example, the polymeric primer layer may contain dyes and/or pigments in order to provide a color to the polymeric primer layer.

In another embodiment, pigmenting the polymeric primer layer to a point where no visible radiation is capable of passing through the polymeric primer layer will provide an enhanced appearance in the metal layer by providing an opaque backdrop. In this embodiment, incorporating a filler, such as carbon black, in the polymeric primer layer provides this feature.

The polymeric primer layer may be provided as a preformed layer such as a self-supporting film, may be case from a solution onto the metal layer, or may be cast from a solution onto a release liner. In one exemplary embodiment, the polymeric primer layer is a self-supporting film, such as an ethylene acrylic acid (EAA) copolymer film.

When present as multiple layers, each polymeric primer layer may contribute to the overall metallized film construction. The additional polymeric primer layer(s) positioned away from the metal layer may serve as a tie layer between the polymeric primer layer adjacent the metal layer and an additional layer (e.g. a polyolefin layer) that has less than desirable adherence to the polymeric primer layer adjacent the metal layer.

Regardless of whether the polymeric primer layer comprises a single layer or multiple layers, the polymeric primer layer adjacent the above-described metal layer has an outer surface that is adjacent the metal layer and conforms to the metal layer surface. For example, as discussed above, in some embodiments of the present invention, the outer surface of the polymeric protective layer adjacent the metal layer is a substantially flat, smooth, planar surface having very little, if any, topographical features thereon. In these embodiments, the subsequently applied metal layer has a substantially planar outer surface on which a polymeric primer layer is applied. In these embodiments, the outer surface of the polymeric primer layer adjacent the metal layer also has a substantially planar outer surface (e.g., a complementary outer surface to the corresponding outer surface of the polymeric protective layer). In other embodiments of the present invention, the outer surface of the polymeric protective layer adjacent the metal layer may have a non-planar surface, such as a surface having topographical features thereon. In these embodiments, the subsequently applied metal layer is a non-planar layer. In these embodiments, the outer surface of the polymeric primer layer adjacent the metal layer has complementary non-planar outer surface that matched the topographical features of the corresponding outer surface of the polymeric protective layer.

Each polymeric primer layer typically has an average thickness of at least about 5 micrometers (μm). Depending on the given application for the corrosion-resistant metallized film, a polymeric protective layer may have an average thickness of greater than 1.0 millimeter (mm) or more. Typically, a polymeric primer layer has a thickness of at least about 10 μm, at least about 15 μm, at least about 50 μm, or at least about 100 μm. The thickness of a polymeric primer layer is usually less than about 50 μm although there is no limitation on the thickness of the polymeric primer layer. In some applications, a polymeric primer layer has a thickness less than about 40 μm, less than about 35 μm, or less than about 30 μm. For example, the thickness can be in the range of about 5 to about 100 μm, or about 10 to about 50 μm, or about 20 to about 30 μm.

In some embodiments of the present invention, the polymeric primer layer serves to isolate the metal layer from an optional adhesive layer that may be present in the overall film construction (see below). The optional adhesive layer is present for the purpose of attaching or anchoring the metallized film to a particular substrate, forming an article of manufacture. Adhesives by their very nature are capable of moving (e.g., flowing) on a micro, as well as a macro scale, which enables the adhesive to interact with an adherend and wet-out against a surface of the adherend. It has been found that if the polymeric primer layer is not present in the film construction, movement of the adhesive layer during application and/or prior to curing of the adhesive may result in destruction of the optical nature of the metal layer. By isolating the optional adhesive layer from the metal layer, any negative effects relating to fluid flow of an optional adhesive layer is minimized.

B. Corrosion-Resistant Metallized Film Construction Parameters

The corrosion-resistant metallized films of the present invention may possess one or more of the following film construction parameters, which contribute to enhanced corrosion resistance.

1. Minimal Charge Potential Across Metal Layer

As described above, the corrosion-resistant metallized films of the present invention desirably possess surface characteristics on either side of the metal layer so as to minimize the charge potential or hydrogen ion transport potential across the metal layer. To minimize the charge potential or hydrogen ion transport potential across the metal layer, outer surfaces of the polymeric protective layer and the polymeric primer layer adjacent the metal layer comprise similarly charged functional groups or polar groups along each surface. In order to provide similarly charged functional groups or polar groups along each surface, each of the polymeric protective layer and the polymeric primer layer may independently comprise (i) at least one polymer or additive having acidic functional groups thereon, (ii) at least one polymer or additive having basic functional groups thereon, (iii) an outer surface adjacent the metal layer having a corona discharge or glow discharge surface treatment, (iv) both (i) and (iii), or (v) both (ii) and (iii).

In one desired embodiment, each of the polymeric protective layer and the polymeric primer layer independently comprise at least one polymer having acidic or basic functional groups thereon. For example, in one desired embodiment, the polymeric protective layer comprises a water-borne or solvent-based acid-functional polyurethane, while the polymeric primer layer comprises an ethylene acrylic acid (EAA) copolymer. In order to further enhance the interaction between the metal layer and the EAA copolymer, the outer surface of the EAA copolymer adjacent the metal layer is corona treated. Desirably, the metal layer comprises tin, aluminum, indium or stainless steel.

In another desired embodiment, the polymeric protective layer comprises a water-borne or solvent-based acid-functional polyurethane, while the polymeric primer layer comprises a cross-linked ethylene acrylic acid (EAA) copolymer, an ethylene vinyl acetate acid terpolymer (cross-linked or uncross-linked), or an olefin-acrylate copolymer having a corona discharge treatment.

2. Minimal Metal Layer Surface Conductivity or Maximum Metal Layer Surface Resistivity

In some embodiments, the corrosion-resistant metallized films of the present invention also comprise a metal layer having a minimal metal layer surface conductivity or a maximum metal layer surface resistivity. As discussed above, in some embodiment, it is desirable for the metal layer to have a surface resistivity of at least about 2.0 ohms/cm², more desirably, at least about 4.0, at least about 6.0, at least about 8.0, or at least about 10.0 ohms/cm². In one desired embodiment of the present invention, the corrosion-resistant metallized film comprises (1) polymeric protective and primer layers, each of which have similarly charged functional groups or polar groups along outer surfaces adjacent the metal layer due to each of the polymeric protective and primer layers independently comprising (i) at least one polymer or additive having acidic functional groups thereon, (ii) at least one polymer or additive having basic functional groups thereon, (iii) an outer surface adjacent the metal layer having a corona discharge or glow discharge surface treatment, (iv) both (i) and (iii), or (v) both (ii) and (iii), and (2) a metal layer sandwiched therebetween, wherein the metal layer has a surface resistivity of at least about 2.0 ohms/cm², more desirably, at least about 10.0 ohms/cm².

### II. Articles of Manufacture Including a Corrosion-Resistant Metallized Film

The present invention is further directed to articles of manufacture, which include one or more of the above-described corrosion-resistant metallized films. The articles of manufacture of the present invention may comprise one of more of the following components in addition to the polymeric primer layer, the metal layer, and the polymeric protective layer described above.

A. Adhesive Layer

Articles of the present invention may include at least one of the above-described corrosion-resistant metallized films in combination with at least one adhesive layer, for example, when an outer surface of the above-described corrosion-resistant metallized film does not possess a desired degree of adhesive properties (e.g., when an outer surface of the polymeric primer layer does not possess adhesive properties). Suitable adhesive layers include, but are not limited to, pressure-sensitive adhesive layers, heat-activatable adhesive layers, or a combination thereof.

Any suitable adhesive polymer can be included in the adhesive layer. The adhesive polymer can be thermoplastic, thermosetting, or a combination thereof. The adhesive surface can be tacky at room temperature (e.g., pressure-sensitive) or after application of heat (e.g., heat-activatable). Suitable thermoplastic adhesives include, but are not limited to, polyolefins, polyurethanes, epoxies, nylon, acrylics, and combinations thereof. Suitable thermosetting adhesives include, but are not limited to, one or two part epoxies, one or two part polyurethanes, one or two part acrylics, or combinations thereof.

Suitable pressure-sensitive adhesives and heat-activatable adhesives for use in the present invention include, but are not limited to, adhesives disclosed in U.S. Pat. No. RE024906 and EP 0384598, the disclosures of which are incorporated herein by reference in their entirety. The adhesive may include a surface topography to provide air-bleed capabilities to the adhesive, provide repositionability, or both.

In an exemplary embodiment of the present invention, the article of manufacture comprises a corrosion-resistant metallized film having an adhesive layer on an outer surface of the polymeric primer layer. The article may be attached to a substrate via the adhesive layer to provide a metallic appearance to the substrate. The article may be attached to the substrate using pressure with or without heat.

B. Release Liner(s)

Articles of the present invention may further include at least one release liner in addition to the above-described layers of the corrosion-resistant metallized films. As described above, a first release liner may be used to provide support for the polymeric protective layer, as well as temporary protection of the polymeric protective layer prior to removal of the first release liner. When a tacky adhesive layer (e.g., a pressure-sensitive adhesive layer) is present in an article of the present invention, such as the polymeric primer layer or on an outer surface of the polymeric primer layer, a second release liner may be used to provide temporary protection of the adhesive layer prior to removal of the second release liner. Such an exemplary article is shown in FIG. 5.

As shown in FIG. 5, exemplary article 20 comprises a corrosion resistant metallized film comprising polymeric primer layer 11, metal layer 12, and polymeric protective layer 13. In addition, article 20 comprises a first release liner 14 on an outer surface of polymeric protective layer 13, adhesive layer 15 on an outer surface of polymeric primer layer 11, and a second release liner 16 on an outer surface of adhesive layer 15.

The first and second release liners typically include one or more layers of materials. In some embodiments, the release liner contains a layer of paper, polyester, polyolefin (e.g., polyethylene or polypropylene), or other polymeric film material. The release liner can be coated with a material to decrease the amount of adhesion between the release liner and the adhesive layer. Such coatings can include, for example, a silicone or fluorochemical material. Any commercially available release liner may be used in the present invention.

As discussed above, first release liner 14 may be used to provide topographical features to the outer surface of polymeric protective layer 13. In addition, if desired, second release liner 16 may be used to provide topographical features to the outer surface of adhesive layer 15. For example, either release liner may provide a uniform (or non-uniform) pattern of valleys and/or ridges along an outer surface of polymeric protective layer 13 and/or adhesive layer 15. In other embodiments, either release liner may be used to provide an outer surface of polymeric protective layer 13 and/or adhesive layer 15 with a substantially smooth surface. As discussed above, release liners suitable for use in the present invention include, but are not limited to, release liners disclosed in U.S. Published Patent Application Nos. 20040048024 and 20030129343 (now, U.S. Pat. No. 6,984,427), the disclosures of which are incorporated herein by reference in their entirety.

FIG. 6 provides a view of article 20 of FIG. 5 attached to a given substrate after first release liner 14 and second release liner 16 have been removed. Once second release liner 16 has been removed, article 20 may be attached to substrate 18 using pressure with or without heat. Substrate 18 may be any substrate including, but not limited to, a polymeric substrate (e.g., a film, a foam, a molded article, etc.), a glass substrate, a ceramic substrate, a metal substrate, a fabric, etc. Articles of the present invention may be useful in the preparation of various decorative items including, but not limited to, badging for automobiles and appliances, emblems, mirror films, solar reflecting films, decorative film laminates, graphics, etc. For some uses, one or layers of article 20 may be colored.

C. Thermoformable Layer(s)

Articles of the present invention may include at least one of the above-described corrosion-resistant metallized films in combination with at least one thermoformable layer. One or more thermoformable layers may be positioned on an outer surface of the polymeric protective layer, the polymeric primer layer, or both. Thermoformable layers may be adhesively attached to the corrosion-resistant metallized film via the polymeric primer layer, an additional adhesive layer, or may be a component (e.g., a layer) used during the formation of the polymeric protective layer, the polymeric primer layer, or both. The resulting thermoformable article comprising at least one of the above-described corrosion-resistant metallized films in combination with at least one thermoformable layer may be thermoformed to form a thermoformed article comprising a corrosion-resistant metallized film. Any conventional thermoforming technique (e.g., molding) may be used to form the thermoformed article.

Thermoformable materials suitable for use in the present invention include, but are not limited to, any thermoplastic material, a thermosettable material, or a combination thereof. Thermoplastic materials such as ABS (acrylonitrile/butadiene/styrene), polycarbonate, polyester, polyurethane, polypropylene, polyethylene, and polyolefin blends are examples of useful thermoformable materials. In one desired embodiment, the thermoformable layer comprises an engineering thermoplastic material. Suitable engineering thermoplastic materials include, but are not limited to, polycarbonates, polyesters (e.g., polybutylene terephthalate), some polyethylenes, polyamides, polysulfones, polyetheretherketones (PEEK), ABS (acrylonitrile/butadiene/styrene), SAN (styrene/acrylonitrile), polyurethanes, polyacrylics, and blends thereof.

The resulting thermoformable or thermoformed articles may be used in a variety of applications. In one exemplary embodiment, the thermoformable or thermoformed articles are used in signage, such as outdoor signage and backlit displays. Such displays typically comprise a box, which houses a light fixture, wherein the front face of the box housing is covered with a film. One such device in which the front face is covered with a transparent film is described in U.S. Pat. No. 5,224,770, the disclosure of which is hereby incorporated in its entirety by reference. Another such device in which the front face is covered with a perforated film is described in U.S. Patent Publication No, 2002/0034608, the disclosure of which is hereby incorporated in its entirety by reference. In the '608 publication, a perforated film is placed over a housing so that the film reflects light during the day to display an image, but can be backlit at night to illuminate an image from behind the film.

In the present invention, the metallized films may be used similar to the transparent film in the '770 patent and the '608 publication. The metallized films of the present invention and thermoformable or thermoformed articles made therefrom have sufficient light transmission, typically about 15-25% light transmission, so as to illuminate the sign from the backside at night or in the dark. The metallized films desirably comprise enough metal coated on the film so as to reflect light during the daytime or in a lit room to display an image, e.g. a three-dimensional image that was thermoformed in the film. In one specific embodiment of the present invention, the film is imaged (e.g., graphics are applied to the metallized film) on the polymeric protective layer side and is then coated with a pressure sensitive or heat activated adhesive on the polymeric primer side. The film can then be laminated to a suitable polymeric material, such as an engineering thermoplastic, and then thermoformed to a desired shape to form a cover for a housing containing a light. Alternatively, the film can be laminated to the thermoplastic and thermoformed to provide a three dimensional image. Such constructions are suitable for daylight/nighttime signage.

D. Additional Top Coat Layer(s)

Articles of the present invention may include at least one of the above-described corrosion-resistant metallized films in combination with one or more additional top coat layers provided on an outer surface of the polymeric protective layer. Suitable top coat layer materials include, but are not limited to, polymeric materials used to form the above-described polymeric protective layer. When present, the one or more additional top coat layers (i) provide some form of protection to the polymeric protective layer (e.g., UV protection, scratch resistance, weather resistance, etc.), (ii) acts as a tie layer between the polymeric protective layer and an additional layer that has less than desirable adherence to the polymeric protective layer (e.g. a polyolefin layer), or (iii) both (i) and (ii).

E. Permanently Attached Substrate(s)

Articles of the present invention may include at least one of the above-described metallized films in combination with one or more permanently attached substrate layers provided on an outer surface of the polymeric protective layer, the polymeric primer layer or both. As discussed above, suitable substrate layers (e.g., exemplary substrate 18 shown in FIG. 6) include, but are not limited to, a polymeric substrate (e.g., a film, a foam, a molded article, etc.), a glass substrate, a ceramic substrate, a metal substrate, a fabric, etc. In one desired embodiment of the present invention, the substrate comprises an elastomeric substrate.

### EXAMPLES

### Test Methods

### Optical Density

The optical density is a measure of how transmissive a metallized film is to light. Optical Density is calculated by taking the negative logarithm of the light transmittance of the film. The transmittance is measured using a Macbeth TD504 densitometer.

### Surface Resistivity

The test shows an approximate surface resistivity of the metal coating. A 717 Conductance monitor manufactured by Decom Instruments Inc. is used to measure surface resistivity by placing a film sample between the sample probe and activating the meter. The surface resistivity is recorded in ohms/cm². Surface conductivity is the reciprocal of the resistance units and is recorded in mhos.

### Tape Snap Test

This test provides an assessment of how well a film construction remains together after exposure to various conditions. A sample of the film or an article formed by backfilling the thermoformed film is adhered to a painted panel. The panel is then aged using one of the conditions listed below. A separate panel is used for each condition.
Moisture Resistance—exposed for 250 hours at 49° C. and 98% Relative Humidity
Salt Spray—exposed for 250 hours at 35° C. using a 5% sodium chloride solution in a salt fog chamber
Thermal Cycling—aged in a chamber through 5 consecutive cycles. Each cycle consists of 16 hours at 79° C./24 hours at 98% relative humidity and 38° C./8 hours at −29° C.
Water Immersion—immersed in 40° C. water for 10 days.

After aging, the panel is dried if needed, and then conditioned overnight at room temperature (about 22° C.). The film, or the backfilled article, is then cross-hatched with a razor blade to form a grid of either 20 or 25 squares each measuring about 1 mm by 1 mm. A strip of 610 Tape (available from 3M Company, St. Paul Minn.) is adhered over the cross-hatched area using firm finger pressure, and then the tape is snapped off with a quick pull. If any squares are removed with the tape, the number of squares is recorded, e.g., 6/25 meaning that 6 squares were adhered to the tape out of a 25 square grid, as well as the failure mode. Alternatively, the results may be recorded as a percentage of the number of squares that remained adhered to the film, e.g., 5/25 would have 5 squares removed by the tape, and the remaining squares have 80% Adhesion. The failure mode describes in which layer the delamination occurred as follows: Pass or 100% Adhesion—all of the squares remained intact on the film with no delamination; Clear—the polyurethane film peeled cleanly with no visible metal on the film; C-M—the metal layer cohesively split resulting in residual metal on both the polymeric protective layer and polymeric prime layer.

### Copper Accelerated Salt Spray (CASS)

This is an accelerated test to determine the corrosion resistance of a film sample. A salt spray solution was prepared by adding 190 grams of sodium chloride, 1 gram of cupric chloride, and 2 milliliters of glacial acetic acid to one gallon of deionized water. After 15 minutes, the solution is stirred with a plastic rod as needed to dissolve the salt. The pH of the solution should be between 3.0 and 3.1. If needed, the pH is adjusted with 0.5 milliliter of glacial acetic acid, or with sodium hydroxide pellets to obtain the desired pH. The salt spray is added to a reservoir of a salt fog chamber and allowed to run overnight to produce a fog and stabilize the temperature to about 50° C. The film sample, measuring 2.54 cm (1 inch) by 7.62 cm (3 inches), or a part to be tested (having thereon a film sample), is adhered to a painted metal panel, with at least 2 edges of the sample exposed. The panel is placed at about a 30 degree angle in the chamber for 24 hours unless otherwise specified in the examples. After exposure, the sample is inspected under a microscope for corrosion. The results are recorded qualitatively as follows:

None—no appearance of corrosion.

Slight—a slight amount of corrosion can be seen on the edges with most of the edge of the film still intact; edges exhibit a slight amount of metal loss, e.g., up to about 0.51 mm (20 mils) into the edge of the sample

Moderate—corrosion can be seen on the exposed edges up to about 0.64 cm (0.25 inch) from the edge.

Severe—corrosion can be seen along the edges and over 0.64 cm (0.25 inch) from the edges, and corrosion, e.g., loss of metal, can extend through to the center of the sample.

Further information on this test method can be found in ASTM Test Method B368-97 Standard Method for Copper-Accelerated Acetic Acid-Salt Spray (Fog) Testing (CASS Test).

### 10-Day Salt Spray

The sample is adhered to a painted metal panel with at least two edges of the sample exposed. The test is conducted in a salt fog chamber for a period of 10 days.

### Gasoline Resistance

The sample is soaked in gasoline for 30 minutes and dried. The appearance of the film is inspected for wrinkling, delamination, loss of gloss, or any other surface flaws resulting from the test.

### Heat Aging

A film sample is adhered to a painted metal panel with at least 2 edges of the sample exposed, and placed in a chamber set at a temperature of 90° C. for 250 hours.

The following materials were used in the Examples below:

U910, U911 and U933 PUD resins—polyurethane dispersion resins available from Alberdingk Boley, Inc. (Charlotte, N.C.)

BYK 331 surfactant—silicone based defoamer/flow agent available from BYK Chemie USA, Inc. (Wallingford, Conn.),

BYK 348—available from BYK Chemie USA, Inc. (Wallingford, Conn.)

DYNASYLAN® MTMO—mercaptopropyl trimethoxy silane available from Degussa Corp. (Parsippany, N.J.)

TINUVIN® 292—hindered amine light stabilizer available from Ciba Specialty Chemicals (Basel, Switzerland)

TINUVIN® 1130—benzotriazole type UV absorber available from Ciba Specialty Chemicals (Basel, Switzerland)

TINUVIN® 123—hindered amine light stabilizer available from Ciba Specialty Chemicals (Basel, Switzerland)

CoSORB—benzophenone-type UV absorber (2-ethylhexyl-2-cyano-3,3-diphenylacrylate) available from Sigma Aldrich (St. Louis, Mo.)

TRITON GR-7M—sulfosuccinate type anionic surfactant available from Dow Chemical Company (Midland, Mich.)

AMP95—aminomethyl propanol pH adjuster available from Angus Chemical (Buffalo Grove, Ill.)

NEOCRYL® CX-100*-aziridine resin available from DSM (Heerlen, Netherlands)

BAYHYDROL 121 PUD—water-based polyester polyurethane dispersion (PUD) available from Bayer MaterialScience LLC (Pittsburgh, Pa.)

DOWANOL PM Acetate—propylene glycol monomethyl ether acetate available from Dow Chemical Company (Midland, Mich.)

DESMODUR Z-4470—polymeric isophorone diisocyanate available from Bayer MaterialScience LLC (Pittsburgh, Pa.)

DESMOPHEN 651-A65—saturated polyester polyol available from Bayer MaterialScience LLC (Pittsburgh, Pa.)

DESMOPHEN 670-80—polyester polyol available from Bayer MaterialScience LLC (Pittsburgh, Pa.)

Cabsol—is a solution containing 80% carbitol acetate solvent with 20% of 0.1 second Cellulose Acetate Butyrate which is available from Eastman Chemical Co. (Kingsport, Tn)

PRIMACOR 3330 is available from Dow Chemical Company (Midland, Mich.)

MACROMELT 6240 is available from Henkel Adhesives (Elgin, Ill.)

Polyaziridine Solution—50 parts of NEOCRYL® CX-100 (available from DSM) in 50 parts of deionized water.

UV Stabilizer Preparation—compositions were prepared by mixing the materials in Table 1 to obtain clear yellowish solutions.

TABLE 1
UV Stabilizer Compositions

| Material | UV Stabilizer I (parts) | UV Stabilizer II (parts) |
|---|---|---|
| TINUVIN ^{®} 292 | — | 10.2 |
| TINUVIN ^{®} 1130 | — | 17.3 |
| TINUVIN ^{®} 123 | 3.22 | — |
| CoSORB | 9.75 | — |
| TRITON GR-7M | 2.48 | 3.9 |
| BYK 331 | — | — |
| AMP95 | — | 1.9 |
| Deionized water | — | 66.7 |
| Butyl Carbitol | 84.55 | — |

### Evaporative Metallization Process

A film (e.g., a polyurethane film) on a polyester release film was loaded around the cooling drum of a metal vapor coating chamber with the film side to be coated positioned away from the drum. The cooling drum temperature was set at 15.6° C. (60° F.) and the chamber was pumped down to a vacuum of about 3×10⁻⁵ torr. Behind a shuttered aperture, an electron beam gun was used to heat two graphite crucibles holding the metal by gradually increasing the power to a setting of 220 milliAmps. The film was pulled over the cooling drum at a speed of 3.05 mpm (10 feet/minute) past the partially opened aperture exposing the film to vaporous metal and allowing the metal to condense onto the film to form a metallized film.

### Sputter Metallization Process

A film (e.g., a polyurethane film) on a polyester release film was loaded into a magnetron sputter coating chamber having a cooling drum with the film side to be coated positioned away from the drum. The drum temperature was set at 15.6° C. (60° F.) and the chamber was pumped down to a vacuum of about 2.5×10⁻⁵ torr. The magnetron was set at 10 Amps, and the argon gas, at a flow rate of 150 standard cubic centimeters (seem), was used to strike a magnetized metal target, forming vaporous metal. The vaporous metal was directed to the film where it condensed to form a metallized film.

### Comparative Examples C1-C6 and Examples 1-2

A polyurethane dispersion was prepared by mixing 87.43 g (grams) of BAYHYDROL 121 PUD and 10.87 g of parts of the UV Stabilizer I. Then, 1.5 g of a polyaziridine solution (50 parts of NEOCRYL® CX100 in 50 parts deionized water) was slowly added to the dispersion, followed by the addition of 0.2 g of BYK 331 surfactant. The dispersion was coated onto a smooth silicone coated 50.8 μm (2 mils) thick polyester film using a notched bar coater with a gap setting of 152.4 μm (6 mils) between the film and the bar coater. The coater speed was set at 1.52 mpm (5 feet/minute) and the film was dried in a 3-zone oven with oven temperatures set at 79.4° 1140.6°/198.9° C. (175°/285° 1390° F.) to form a polyurethane film. Each oven zone was about 3.66 m (12 feet) long.

Part A of a two-part polyurethane composition was prepared by mixing the following: 27.4 g DOWANOL PM Acetate, 27.4 g methyl isobutyl ketone, 10.4 g of DESMOPHEN 651-A65 polyol, 25.43 g of DESMOPHEN 670-80 polyol, 0.49 g of TINUVIN® 123 UV stabilizer, 1.55 g CoSORB UV stabilizer, 5.3 g CABSOL, 1.14 g 2,4-pentanedione, and 0.06 g dibutyl tin dilaurate.

A two-part polyurethane composition was prepared by mixing 99.17 g of Part A with 24.68 grams of DESMODUR Z-4470 polyisocyanate with a paddle mixing blade for about 5 minutes to form a uniform solution. The solution was then coated onto the polyurethane film using a dip roll coater with the coating gap set at 50.8 μm (2 mils) at a line speed of 1.52 mpm (5 feet/minute), and dried and cured in the 3-zone oven with temperatures set at 82.2°/171.1°/198.9° C. (180°/340°/390° F.). The resulting 2-layer polyurethane film had a thickness of about 76.2 μm (3 mils).

The polyurethane film, supported on the silicone coated polyester film, was used to prepare Comparative Examples C1-C6 and Examples 1-2 as shown in Table 1. The examples were prepared with or without corona treatment of the polyurethane film, metallized with tin using the evaporative metallization or the sputter metallization process, and laminated to a PA primer (12.7 μm (0.5 mil) thick polyamide MACROMELT 6240 on a paper release liner) or to an EAA primer (ethylene acrylic acid—30.5 μm (1.2 mil) thick PRIMACOR 3330 on a polyester release liner). The EAA had been cross-linked by exposing the EAA to 5 Mrads of electron beam radiation at 175 kV).

Corona treated films were treated at a speed of 3.05 mpm (10 feet/minute) in air with a power setting of 26 Hz and 250 watts. The polyamide primer was laminated to the metal layer using a hot can set at 93.3° C. (200° F.), while the EAA primer was laminated to the metal layer using a hot can set at 112.8° C. (235° F.).

The primed metallized films were thermoformed, and then backfilled, and adhesive coated as described in the examples in U.S. Patent Publication No. 2004/0234771, the subject matter of which is incorporated herein by reference, to form three-dimensional parts having a thickness of about 1.5 millimeters. The finished parts were tested according to the Tape Snap Test described above after exposing to various conditions shown in Table 2.

TABLE 2
Constructions and Test Results for Examples C1-C6 and Examples 1-2

| | C1 | C2 | C3 | C4 | C5 | C6 | 1 | 2 |
|---|---|---|---|---|---|---|---|---|
| Corona Treated | No | No | Yes | Yes | No | No | Yes | Yes |
| Metallization | Evap | Sputter | Evap | Sputter | Evap | Sputter | Evap | Sputter |
| Primer | PA | PA | PA | PA | EAA | EAA | EAA | EAA |
| Moisture | 20/20 | 4/20 | 2/20 | 2/20 | 25/25 | Pass | Pass | Pass |
| Resistance | C-M | C-M | C-M | C-M | Clear | | | |
| Salt Spray | 20/20 | 6/20 | Pass | 11/25 | 25/25 | 3/25 | Pass | Pass |
| | C-M | C-M | | C-M | Clear | C-M | | |
| Thermal | 20/20 | 11/25 | Pass | 25/25 | 25/25 | Pass | Pass | Pass |
| Cycling | Clear | C-M | | Clear | Clear | | | |
| Water | 20/20 | 25/25 | 6/25 | Not | 25/25 | 6/25 | Pass | Pass |
| Immersion | C-M | C-M | C-M | Tested | Clear | C-M | | |

The above examples show that the use of corona treatment provided enough functionality on the surface of the solvent-based polyurethane (which by itself does not have acidic functionality) to provide an integral bond with the metal layer. The use of an ethylene acrylic acid primer further improved the corrosion resistance of the film. The use of the polyamide primer (which is basic) did not hold up as well. While sputter metal coating improved the strength of the laminate, corona treatment with an EAA primer provided superior results.

### Example 3

A polyurethane dispersion was prepared by mixing 93.21 parts of BAYHYDROL 121 PUD, 4.82 parts of the UV Stabilizer II, 1.5 parts of polyaziridine solution, and 0.47 part of red iron oxide pigment dispersion (available under the trade designation “AQ Trans Red Iron Oxide” Product Code RD-29911 from Penn Color Inc., Doylestown, Pa.).

The polyurethane dispersion was coated onto a smooth silicone coated 50.8 μm (2 mils) thick polyester film using a notched bar coater to with a gap setting of about 76.2 μm (3 mils) between the film and the bar. The dispersion was coated at a speed setting of 1.52 mpm (5 feet/minute) and dried in a 3-zone oven of Example 1 with the temperatures set at 160/182.2/198.9° C. (320°/360°/390° F.) to form a polyurethane film having a thickness of about 25.4 μm (1 mil). The film was corona treated and metallized with tin using the Evaporative Metallization process, and laminated to a cross-linked EAA primer as described in Example 1. Three-dimensional parts were prepared according to the method of Example 1, and parts were tested for Tape Snap after aging as follows: 10-day Salt Spray, Gasoline Soak, C.A.S.S. for 20 hours, Water Immersion, and Heat Aging at 80° C. Results are summarized in Table 3 below.

### Comparative Example C7

Three-dimensional parts were prepared and tested according to the procedure of Example 3 except that the primer layer was polyamide (MACROMELT 6240).

TABLE 3
Test Results for Examples 3, C1 and C7

| | Example 3 | Example C7 | Example C1 |
|---|---|---|---|
| Tape Snap - 10-Day | 100% Adhesion | 75% Adhesion | 25% Adhesion C-T |
| Salt Spray | | C-T | |
| Tape Snap - Gasoline | 100% Adhesion | 100% Adhesion | 95% Adhesion |
| Soak | No effect | Severe wrinkling | Severe deglossing |
| | | | Slight wrinkling |
| Tape Snap - Water | 100% Adhesion | 32% Adhesion | 0% Adhesion |
| Immersion | | | |
| Tape Snap - Heat | 100% Adhesion | 100% Adhesion | 100% Adhesion |
| Aging | | | |
| C.A.S.S. Corrosion | None | Slight | Severe |

The above examples indicate the difference between (i) a water-based polyurethane containing benzotriazole that has been corona treated and bonded to an EAA (acid) primer layer and (ii) a water-based polyurethane containing benzotriazole that has been corona treated and bonded to a polyamide (basic) primer layer.

### Examples 4-12

A polyurethane dispersion was prepared by mixing 93.64 parts of BAYHYDROL 121, 4.86 parts of UV Stabilizer II, and 1.5 parts of polyaziridine solution. The solution was coated with a slot-fed knife to provide a wet coating thickness of about 127 μm (5 mils) at a line speed of 2.74 mpm (9 ft/min). The oven temperatures for each zone were set at 137.8/160/176.7° C. (280°/320°/350° F.). The resulting film had a thickness of about 25.4 μm (1 mil). In Examples 7-12, the film was treated with an oxygen glow in which the film was exposed to an oxygen plasma under a vacuum of about 3×10⁻² torr with oxygen fed into the glow chamber at 185 sccm. The film was treated at a speed of 9.14 mpm (30 ft/min) at 5 kV (kilovolts) with either 30 or 50 mA (milliAmperes) of power as indicated in Table 4. The treated films were coated with tin using the Evaporative Metallization process except that the power was set at 320 mA and the tin coating speed was varied as shown in Table 4. The films were measured for optical density (average of 10 to 11 readings across the web) and surface resistance. The films were then hot laminated to a cross-linked EAA primer layer according to the procedure of Example 3. Samples measuring about 2.54 cm (1 inch)×7.62 cm (3 inches) were cut from each example using an Olfa knife. The samples were mounted onto a painted panel using SCOTCH® Tape #838, across 1.27 cm (0.5 inch) on one edge of the film and across 1.27 cm (0.5 inch) on the opposite edge of the film so that approximately 5.08 cm (2 inches) of each of the side edges were exposed, and tested for C.A.S.S. Corrosion. Test results are shown in Table 4 below.

TABLE 4

| | | Tin Coating | | | | |
|---|---|---|---|---|---|---|
| | Glow | Speed mpm | Optical | Resistance | Conductance | C.A.S.S. |
| Ex | mA | (ft/min) | Density | ohms/cm² | mhos | Corrosion |
| 4 | None | 3.05 (10) | 3.61 | 1.695 | 0.590 | Moderate |
| 5 | None | 6.10 (20) | 1.60 | 6.310 | 0.277 | Moderate |
| 6 | None | 9.14 (30) | 0.59 | 21.739 | 0.046 | None |
| 7 | 30 | 3.05 (10) | 3.54 | 1.736 | 0.576 | Slight |
| 8 | 30 | 6.10 (20) | 1.06 | 4.202 | 0.238 | Slight |
| 9 | 30 | 9.14 (30) | 0.77 | 40.000 | 0.025 | None |
| 10 | 50 | 3.05 (10) | 3.28 | 1.305 | 0.760 | Slight |
| 11 | 50 | 6.10 (20) | 0.76 | 3.195 | 0.313 | Slight |
| 12 | 50 | 9.14 (30) | 0.74 | 15.625 | 0.064 | None |

The above examples show the effect of metal thickness on the corrosion behavior of metallized films.

### Examples 13-16

Polyurethane dispersions were prepared according to the procedure of Example 1 except using the compositions, in parts, shown in Table 5 below. The glow treated examples were treated with oxygen according to the process of Example 4 except that 40 mA and 2.1 kV were used. The films of all four examples were coated with tin using the Evaporative Metallization process except that the power was adjusted to 320 mA and the web speed was 9.14 mpm (30 fpm). All four of these films were then combined with an EAA primer layer using the hot lamination procedure of Example 1. Samples were then cut and mounted on paint panels for testing according to the procedure of Example 4. Test results are shown in Table 5 after 48 hours of C.A.S.S. exposure.

TABLE 5

| | Example 13 | Example 14 | Example 15 | Example 16 |
|---|---|---|---|---|
| BAYHYDROL 121 | 91.53 | 91.53 | 92.34 | 92.34 |
| UV Stabilizer II | 5.66 | 5.66 | 5.71 | 5.71 |
| Polyaziridine | 1.47 | 1.47 | 1.48 | 1.48 |
| solution | | | | |
| BYK 348 | 0.46 | 0.46 | 0.46 | 0.46 |
| DYNASYLAN MTMO | 0.89 | 0.89 | -0- | -0- |
| Glow Treated | Yes | No | Yes | No |
| C.A.S.S. Test | None | None | None | Moderate |
| Results - Corrosion | | | | |

The above examples illustrated the advantages to corrosion protection of the metallized films due to (i) glow treating and (ii) the incorporation of a mercapto compound into the polymeric protective layer.

### Example 17-20

Metallized polyurethane films of Examples 17-20 were prepared according to the procedure for Examples 13-16, respectively. A primer layer composition was prepared by mixing 92.34 parts of Alberdingk Boley U910, 5.71 parts of UV Stabilizer II, and 1.48 parts of aziridine solution. The composition was coated to a thickness of about 76.2 μm (3 mils) onto the exposed tin surface of each example, and dried and cured for 5 minutes in an oven set at 71.1° C. (160° F.). The films were conditioned overnight at about 20° C. Film samples were then adhered to painted panels and the panels were exposed to 4 hours of C.A.S.S., inspected for corrosion. Another set of panels were exposed to another 24 hours of C.A.S.S., and inspected. Results are shown in Table 6 below.

TABLE 6

| | Example 17 | Example 18 | Example 19 | Example 20 |
|---|---|---|---|---|
| DYNASYLAN MTMO in | 0.89 | 0.89 | -0- | -0- |
| Clear Coat | | | | |
| Glow Treated | Yes | No | Yes | No |
| C.A.S.S. - Corrosion | None | None | None | Moderate |
| after 4 hrs | | | | |
| C.A.S.S. - Corrosion | None | None | Slight | Slight |
| after 24 hours | | | | |

### Comparative Examples C8-C11

Metallized polyurethane films for Examples C8-C11 were prepared according to Examples 13-16, respectively. The films were primed with MACROMELT 6240 according to the procedure of Example C1. The film samples were mounted onto painted panels and then exposed to 4 hours and 24 hours of C.A.S.S. exposure. Results are shown in Table 7 below.

TABLE 7

| | Example C8 | Example C9 | Example C10 | Example C11 |
|---|---|---|---|---|
| DYNASYLAN MTMO in | 0.89 | 0.89 | -0- | -0- |
| Clear Coat | | | | |
| Glow Treated | Yes | No | Yes | No |
| C.A.S.S. corrosion | Slight | Slight | Slight | Slight |
| after 4 hrs | | | | |
| C.A.S.S. corrosion | Slight | Slight | Severe | Severe |
| after 24 hours | | | | |

Comparative Examples 17-20 indicated that the polyamide primer did not provide adequate corrosion protection even with the mercapto silane present in the polymeric protective layer.

### Examples 21-24

A polyurethane film was prepared according to the procedure of Example 15 except that the Alberdingk-Boley PUD resin U933 (waterborne polycarbonate-based polyurethane) was used instead of BAYHYDROL 121. The film was treated by oxygen glow using a current of 50 mA at a line speed of 9.14 mpm (30 ft/min). The oxygen flow into the glow chamber was 195 sccm under a vacuum of 3×10⁻² torr. The treated film was coated with indium using the evaporative metallization process described above except the vacuum chamber was pumped down to about 1×10⁻⁵ torr. The current on the electron beam gun used to heat the crucibles was increased gradually to 20 mA. The film was then coated by pulling the polyurethane film web through the coating chamber at 3.05, 6.10, 9.14 and 12.19 mpm (10, 20, 30 and 40 ft/min). for Examples 21, 22, 23, and 24, respectively. The amount of indium deposited decreased with increased line speed. The films were then hot laminated to the EAA primer according to the procedure of Example 1. Film samples were cut and mounted onto two paint panels. One panel was placed in the CASS chamber for 4 hours and the other was exposed for 24 hours. Results are shown in Table 8.

TABLE 8

| | Example 21 | Example 22 | Example 23 | Example 24 |
|---|---|---|---|---|
| Metallization Line | 3.05 (10) | 6.10 (20) | 9.14 (30) | 12.19 (40) |
| Speed - mpm (ft/min) | | | | |
| Optical Density | 1.34 | 0.73* | 0.95 | 0.94 |
| Surface Resistivity | 1.04 | >100 | >100 | >100 |
| ohms/cm² | | | | |
| C.A.S.S. Test | Slight | None | None | None |
| after 4 hrs | | | | |
| C.A.S.S. Test | Severe | None | None | None |
| after 24 hrs | | | | |
| C.A.S.S. Test | Severe Edge | None | None | None |
| after 4 days | | | | |

*The film had severe whitening of the metallic coating on the side on which the metal was deposited. The appearance of the metal surface from the polyurethane film side had an acceptable metallic appearance.

### Examples 25-28

Metallized films were prepared according to the procedure of Examples 21-24 except aluminum was used in place of indium. Test results are shown in Table 9 below.

TABLE 9

| | Example 25 | Example 26 | Example 27 | Example 28 |
|---|---|---|---|---|
| Metallization Line | 3.05 (10) | 6.10 (20) | 9.14 (30) | 12.19 (40) |
| Speed - mpm (ft/min) | | | | |
| Optical Density | 2.77 | 1.16 | 0.66 | 0.43 |
| Surface Resistivity | 1.42 | 3.40 | 8.67 | 14.1 |
| ohms/cm² | | | | |
| C.A.S.S. Test | Severe | No | No | No |
| after 4 hrs | | | | |
| C.A.S.S. Test | Severe | No | No | No |
| after 24 hrs | | | | |
| C.A.S.S. Test | Severe | Edge | Slight | Slight |
| after 4 days | | | | |

### Examples 29-30

A polyurethane dispersion resin supplied by Industrial Copolymers Ltd. under the trade designation INCOREZ 007/129 was coated onto a bare PET liner at a wet thickness of 203.2 μm (8 mils) using a notch bar coating apparatus. The coated liner was placed in a 60° C. (140° F.) oven for 1 hour to insure that the coating was completely dry. This film was then placed in a Denton Vacuum (DV-502A), evaporative lab coater. Two ‘shots’ of tin were loaded into each of the 6 tungsten wire baskets, while the film was taped to an inside surface of the bell. The bell was placed over the chamber and pumped down to a vacuum of approximately 1×10⁻⁵ torr. This operation took approximately 20 minutes. The power load to the wire baskets was raised until a power level of 35 was achieved. The ramp-up took approximately 2 minutes, and was held at a power level of 35 for about 45 seconds. The power load was then rapidly decreased to the first post. The operation was repeated for the second wire basket post. The machine sat for approximately 10 minutes. The chamber of the machine was then purged with nitrogen until atmospheric pressure was achieved.

The film exhibited some areas of whitening due to the heating effect of the baskets but the samples were highly reflective on the surface facing the liner. This sample was then laminated to a cross-linked EAA primer layer as used in Example 1 at 129.4° C. (265° F.) at moderate to slow lamination speeds on the laboratory laminator used in Example 1. This film sample was then thermoformed using female thermoforming mold having the letters ‘JEEP’ on them that were about 1.5 mm deep. The molds were then coated with a two-part polyurethane resin which filled the mold and formed a thin layer of polyurethane on the back side of the sheet. The polyurethane was covered with a 12.7 μm (0.5 mil) thick film of MACROMELT 6240, and laminated to a layer of acrylic foam tape. The thermoforming, backfilling, and lamination processes used in this example are described in EP 0392847, the subject matter of which is incorporated herein by reference. The sample was allowed to cure for approximately 10 minutes and the resulting sheet with the letters ‘JEEP’ on it was then removed from the mold.

The sheet was then cut in half. One half of the sheet for Example 29 had no further processing. For Example 30, the other half of the sheet was run through a PPG Industries Inc. UV processor model QC1202 in the laboratory 5 times at 30.5 mpm (100 fpm) with both UV lamps on a “Full” setting. After exposure, the sheet on the film side of the sample curled, which suggested that there was some cure in the polyurethane clearcoat film due to curing that occurred upon exposure to UV.

Samples of the clear polyurethane films, i.e., without metallization, were also evaluated for tensile and elongation, with and without exposure to UV radiation as described above. The tensile and elongation results shown in Table 5 were an average of 3 samples.

TABLE 5
Tensile & Elongation for Example 2

| | | | Modulus | Elon- | Real |
|---|---|---|---|---|---|
| | Thickness | Peak Load | kN/cm² | gation | Tensile |
| Sample | μm (inch) | Nm (lbf) | (psi) | (%) | (Mpa) |
| Unexposed | 30.48 | 8.11 | 27.22 | 213 | 34.4 |
| | (0.0012 in) | (5.98 lbf) | (39481 psi) | | |
| UV Exposed | 30.48 | 9.00 | 55.21 | 144 | 38.2 |
| | (0.0012 in) | (6.64 lbf) | (80067 psi) | | |

These samples show that there was some level of post-cure of the film as evidenced by the higher tensile and lower elongation of the UV exposed sample. The UV-exposed film enables a user to achieve a high degree of thermoforming definition in a formed part, while forming a part with greater durability.

### Examples 31-41

Metallized films were prepared using the following materials as shown in Table 10 below.

| Example | Protective Layer | Metal Layer | Primer Layer |
|---|---|---|---|
| 31 | Polyurethane | Tin | Ionomer (SURLYN) |
| | (Ex 17) | | |
| 32 | Polyurethane | Tin | Ethylene butyl |
| | (Ex 17) | | acrylate |
| 33 | Polyurethane | Tin | Ethylene vinyl |
| | (Ex 17) | | acetate (EVA) |
| 34 | EVA | Aluminum | EVA |
| 35 | Cross-linked EAA | Aluminum | Cross-linked EAA |
| 36 | Cross-linked EAA | Aluminum | Uncross-linked |
| | | | EAA |
| 37 | UV Post-cross- | Tin | EAA |
| | linked polyurethane | | |
| | (Ex 30) | | |
| 38 | Uncross-linked | Tin | EAA |
| | polyurethane | | |
| | (Ex 29) | | |
| 39 | Polyvinylidene | Tin | EAA |
| | fluoride/acrylic | | |
| | resin blend | | |
| 40 | Thermoplastic | Tin | EAA |
| | polyurethane | | |
| 41 | Polyvinylidene | Aluminum | Polyurethane |
| | fluoride | | (Ex 1) |

### Example 42

A polyurethane dispersion was prepared by mixing 48.82 parts of Alberdingk-Boley PUD resin U933, and 48.82 parts of Alberdingk-Boley PUD resin U911 (water-based polycarbonate polyurethane dispersions available from Alberdingk Boley Inc. (Charlotte, N.C.)), 4.86 parts of UV (ultraviolet light) stabilizer solution, and 1.5 parts of aziridine solution. The UV stabilizer solution was prepared by mixing 10.2 parts of TINUVIN® 292 (hindered amine light stabilizer available from Ciba Specialty Chemicals Corp. (Tarrytown, N.Y.)), 17.3 parts of TINUVIN® 1130 (hydroxyphenyl benzotriazole type UV absorber available from Ciba Specialty Chemicals Corp. (Tarrytown, N.Y.)), 3.9 parts of TRITON™ GR-7M (sodium sulfosuccinate surfactant available from Union Carbide Corp. (Danbury, Conn.)), 9 parts of AMP-95 (aminomethyl propanol, a pH adjuster available from Angus Chemical Co. (Buffalo Grove, Ill.)), and 66.7 parts of deionized water to form a clear yellowish solution. The aziridine solution was 50 parts of NEOCRYL® CX-100 (polyfunctional aziridine available from Neoresins, Inc. (Wilmington, Mass.)) in 50 parts of deionized water.

The polyurethane dispersion was coated to a thickness of approximately 127 μm (5 mils) onto a bare polyester film using a notch-bar coater. The dispersion was dried and cured in a three zone oven with temperatures set at 190°, 350°, and 350° F. in Zones 1, 2, and 3, respectively to form a film having a thickness of about 25.4 μm (1 mil). Each zone was about 3.66 m (12 feet) long. The film was treated by oxygen glow using a current of 50 mA at a line speed of 9.14 mpm (30 ft/min). The oxygen flow into the glow chamber was 195 sccm under a vacuum of 3×10-2 torr.

The polyurethane film on the polyester film was loaded around the cooling drum of a metal vapor coating chamber with the polyurethane side away from the drum. The cooling drum temperature was set at 15.6° C. (60° F.) and the chamber was pumped down to a vacuum of about 3×10⁻⁵ torr. Behind a shuttered aperture, an electron beam gun was used to heat two graphite crucibles holding tin by gradually increasing the power to a setting of 220 milliAmps. The film was pulled over the cooling drum at a speed of 3.05 m/minute (10 feet/minute) past the partially opened aperture exposing the film to vaporous tin and allowing the tin to condense onto the web to form a metallized polyurethane film.

A 30.5 μm (1.2 mil) thick layer of EAA (ethylene acrylic acid commercially available under the trade designation PRIMACOR 3330 from Dow Chemical Co. (Midland, Mich.)) was extruded onto a polyester release film. The EAA layer was cross-linked by exposing it to 5 Mrads of electron beam radiation at 175 kV, and then laminated to the metal layer of the polyurethane film using a hot can set at 129.4° C. (265° F.).

The EAA side of the film was laminated to a layer of 1.5 mil (0.38 micron) thick cross-linked acrylic pressure-sensitive adhesive on a release liner. The hot melt acrylic adhesive had a composition of 95.42 parts 2-methyl butyl acrylate, 3.98 parts acrylamide and 0.60 parts benzophenone that had been cross-linked by exposure to 500 mJ/cm² of UV-A radiation from a medium pressure mercury lamp.

### Example 43 and Reference Example R1

Sheets of 1.59 mm (0.0625 inch) polycarbonate (available from McMaster Carr (Elmhurst, Ill.)) measuring 30.5 cm (12 in) by 30.5 cm (12 in) were dried for 3 hours at 65.6° C. (150° F.).

For Reference Example R1, a sheet of Scotchcal 3635-110 film (available from 3M Company Commercial Graphics Division St. Paul, Minn.) coated with a pressure-sensitive adhesive was laminated to a sheet of polycarbonate to form a laminated stack.

The pressure-sensitive adhesive side of the metallized film of Example 42 was laminated to the polycarbonate sheet to form a laminated stack sample for Example 43. The laminated stack samples were dried at 65.6° C. (150° F.) for 12 hours. After the stacks had cooled to ambient room temperature, the specularity of each of the samples was measured according to the procedure described below.

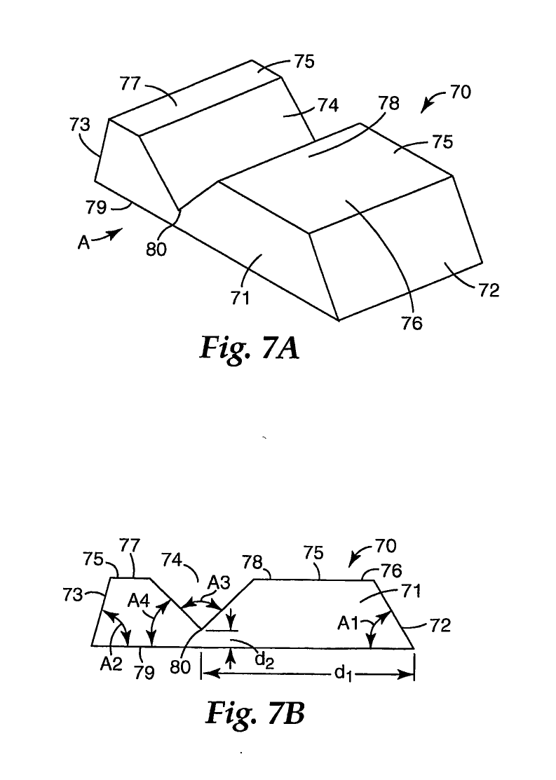

The samples were thermoformed on a Labform 2024 Thermoformer (available from Hydro-Trim Corporation (W. Nyack, N.Y.)) with the polycarbonate side of the stack against the surface of a mold made of medium density fiberboard and having a mold configuration as shown in FIGS. 7A-7B. The stack was heated on both sides for 90 seconds using an oven set at an oven temperature of 229.4° C. (445° F.). The stack was then vacuum formed over the mold for 9 seconds.

As shown in FIGS. 7A-7B, the mold 70 was rectangular having overall length and width dimensions of about 17.8 cm (7 in) by 17.8 cm (7 in) and a height of 3.8 cm (1.5 in). The opposing width edges 71 each had an enclosed angle of 80 degrees. The length edges had an enclosed angle A1 of 60 degrees on one edge 72 and an enclosed angle A2 of 75 degrees on the opposing edge 73. Mold 70 had a V-shaped groove 74 with a 90 degree enclosed angle A3, and positioned a distance, d₁, of 8.9 cm (3.5 in) from edge 72 having an enclosed angle A1 of 60 degrees. Groove 74 divided the planar surface 75 of mold 70 into a large planar surface 76 and a small planar surface 77 with a bottom 80 of groove 74 positioned 9.6 mm (0.38 in) above lower edge 79.

The specularity of the thermoformed film samples were measured as described above in an area 78 on large planar surface 76. A corresponding area of a given film sample had undergone a draw of approximately 10% in area 78. The film of the example produced a thermoformed sheet with a highly specular film on the top surface with a relatively low loss of specularity of the film during thermoforming.

The reflectivity measurements were conducted on a spectrocolorimeter (GretagMacBeth Color-Eye 7000 UV available from GretagMacBeth (New Windsor, N.Y.)). The reflectivity, as a function of wavelength bandpass (from about 350-750 nanometers), was measured for each sample so as to include the specular component and so as to exclude the specular component. The degree of specularity of a given film was determined by calculating the difference in the values of the spectral reflectivity when the specular component was included and when the specular component was excluded. A low value in the reflectivity, i.e., a small difference, at a given bandpass indicates a diffuse reflecting film, i.e., not mirror-like while a large value indicates a highly specular film, i.e., mirror-like.

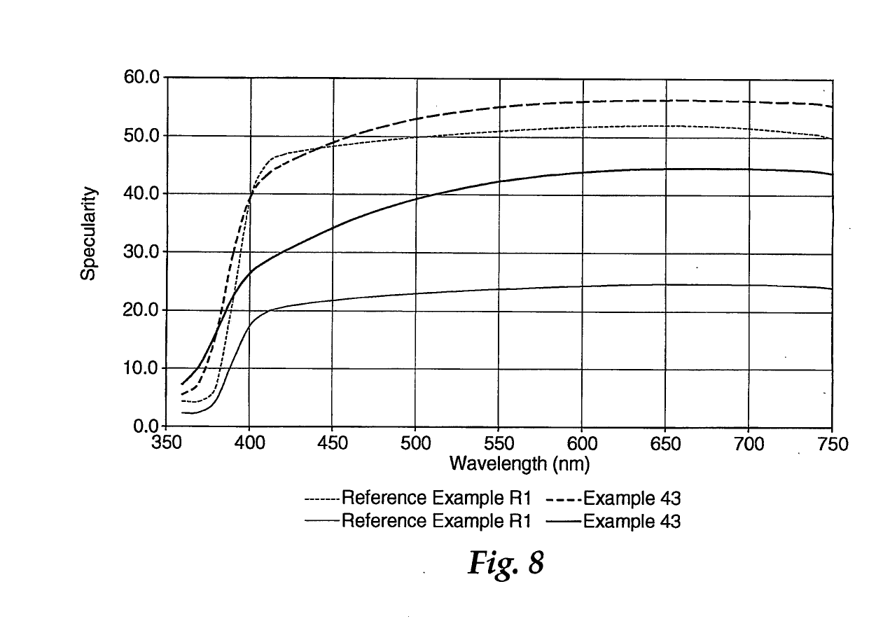

Table 12 below provides the degree of specularity, i.e., the difference between the values with and without the specular component, for the film samples of Example 43 and Reference Example R1 prior to being thermoformed, and the degree of specularity of a given film after being thermoformed. A plot of the difference in specularity for each film sample (i.e., Example 43 and Reference Example R1) is shown in FIG. 8. As shown in FIG. 8, Example 43 of the present invention exhibited a smaller difference in specularity resulting from the thermoforming process step compared to Reference Example R1 (i.e., as shown by the greater distance between line pairs of Reference Example R1).

TABLE 12
Specularity of Films Before and After Thermoforming

Specularity

| Wavelength | Before | After | Before | After |
|---|---|---|---|---|
| (nm) | R1 | R1 | Ex 43 | Ex 43 |
| 360 | 4.2 | 2.3 | 5.6 | 7.8 |
| 370 | 4.1 | 2.5 | 7.7 | 10.9 |
| 380 | 6.6 | 4.5 | 15.9 | 16.6 |
| 390 | 20.9 | 11.0 | 29.9 | 22.9 |
| 400 | 37.3 | 17.2 | 39.6 | 26.8 |
| 410 | 43.2 | 19.7 | 43.4 | 29.0 |
| 420 | 44.8 | 20.6 | 45.3 | 30.5 |
| 430 | 45.5 | 21.1 | 46.7 | 32.0 |
| 440 | 46.1 | 21.5 | 48.0 | 33.3 |
| 450 | 46.6 | 21.8 | 49.1 | 34.6 |
| 460 | 47.1 | 22.1 | 50.1 | 35.8 |
| 470 | 47.5 | 22.4 | 51.0 | 36.9 |
| 480 | 47.9 | 22.6 | 51.8 | 37.9 |
| 490 | 48.2 | 22.8 | 52.5 | 38.9 |
| 500 | 48.6 | 23.0 | 53.2 | 39.7 |
| 510 | 48.9 | 23.2 | 53.7 | 40.4 |
| 520 | 49.2 | 23.4 | 54.1 | 41.1 |
| 530 | 49.5 | 23.6 | 54.5 | 41.7 |
| 540 | 49.8 | 23.7 | 54.9 | 42.3 |
| 550 | 50.0 | 23.9 | 55.3 | 42.8 |
| 560 | 50.2 | 23.9 | 55.5 | 43.2 |
| 570 | 50.5 | 24.1 | 55.8 | 43.6 |
| 580 | 50.6 | 24.2 | 55.9 | 43.9 |
| 590 | 50.8 | 24.3 | 56.1 | 44.2 |
| 600 | 50.9 | 24.4 | 56.2 | 44.5 |
| 610 | 51.0 | 24.5 | 56.3 | 44.7 |
| 620 | 51.2 | 24.6 | 56.4 | 44.8 |
| 630 | 51.2 | 24.7 | 56.4 | 45.0 |
| 640 | 51.3 | 24.7 | 56.5 | 45.1 |
| 650 | 51.3 | 24.7 | 56.5 | 45.1 |
| 660 | 51.3 | 24.7 | 56.5 | 45.2 |
| 670 | 51.3 | 24.8 | 56.5 | 45.2 |
| 680 | 51.2 | 24.8 | 56.5 | 45.2 |
| 690 | 51.1 | 24.7 | 56.4 | 45.2 |
| 700 | 51.0 | 24.7 | 56.3 | 45.1 |
| 710 | 50.8 | 24.7 | 56.3 | 45.0 |
| 720 | 50.6 | 24.6 | 56.1 | 45.0 |
| 730 | 50.3 | 24.5 | 56.1 | 44.8 |
| 740 | 50.1 | 24.4 | 56.0 | 44.7 |
| 750 | 49.4 | 24.1 | 55.5 | 44.2 |

We claim:

1. A corrosion-resistant metallized film comprising:
a polymeric primer layer having a first surface;
a metal layer adjacent the first surface of the polymeric primer layer; and
a polymeric protective layer adjacent the metal layer, said protective layer having a second surface in contact with the metal layer;
wherein the first and second surfaces (i) have a similar surface charge, and (ii) jointly provide corrosion resistance to the metal layer.

2. The corrosion-resistant metallized film of claim 1, wherein the metal layer is a visually continuous layer having a discontinuous conductivity.

3. The corrosion-resistant metallized film of claim 1 or 2, wherein the metal layer has a conductivity of less than about 10 mhos.

4. The corrosion-resistant metallized film of any one of claims 1 to 3, wherein the metal layer has a surface resistivity of at least about 3 ohms/cm².

5. The corrosion-resistant metallized film of any one of claims 1 to 4, wherein the first and second surfaces have: (i) acidic functional groups on the first and second surfaces, (ii) basic functional groups on the first and second surfaces, (iii) a corona discharge or glow discharge surface treatment, (iv) both (i) and (iii), or (v) both (ii) and (iii).

6. The corrosion-resistant metallized film of any one of claims 1 to 5, wherein the polymeric primer layer comprises at least one polymer or additive having acidic functional groups thereon, and the polymeric protective layer comprises at least one polymer or additive having acidic functional groups thereon.

7. The corrosion-resistant metallized film of any one of claims 1 to 6, wherein the polymeric protective layer comprises a polyurethane, a polymer or copolymer containing carboxyl groups thereon, a polyolefin, an ethylene/vinyl acetate/acid terpolymer, an ionomer, a polymer doped with one or more additives containing acidic or basic functional groups, or any combination thereof; and the polymeric primer layer comprises a polyurethane, a polymer or copolymer containing carboxyl groups thereon, a polyolefin, an ethylene/vinyl acetate/acid terpolymer, an ionomer, a polymer having acidic or basic functionality, a polymer doped with one or more additives containing acidic or basic functional groups, or any combination thereof.

8. The corrosion-resistant metallized film of any one of claims 1 to 7, wherein the polymeric protective layer comprises an optically clear layer comprising a polyurethane or a polymer or copolymer containing carboxyl groups thereon; and the polymeric primer layer comprises a polymer having acidic functionality, an additive having acidic functionality, or any combination thereof.

9. The corrosion-resistant metallized film of any one of claims 1 to 8, wherein the polymeric primer layer comprises an ethylene acrylic acid copolymer, an ethylene/vinyl acetate/acid terpolymer, a polyurethane, or any combination thereof.

10. The corrosion-resistant metallized film of any one of claims 1 to 8, wherein the polymeric primer layer comprises an outer adhesive surface opposite the metal layer.

11. The corrosion-resistant metallized film of any one of claims 1 to 10, wherein the polymeric primer layer comprises a pressure sensitive adhesive layer.

12. The corrosion-resistant metallized film of any one of claims 1 to 8, wherein the polymeric primer layer, the polymeric protective layer, or both, comprise at least one polymer and at least one of a mercapto-functional silane or a benzotriazole.

13. The corrosion-resistant metallized film of any one of claims 1 to 8, wherein the polymeric protective layer comprises at least one polymer and at least one of a mercapto-functional silane or a benzotriazole.

14. The corrosion-resistant metallized film of any one of claims 1 to 13, wherein both the first surface and the second surface have an overall positive surface charge.

15. The corrosion-resistant metallized film of any one of claims 1 to 5 and 7, wherein both the first surface and the second surface have an overall negative surface charge.

16. The corrosion-resistant metallized film of any one of claims 1 to 15, wherein the metal layer comprises areas of metallic material, said areas being attached to bond sites along the second surface, wherein the bond sites correspond to a functional group or a treated surface area along the second surface of the polymeric protective layer.

17. The corrosion-resistant metallized film of any one of claims 1 to 16, wherein the polymeric primer layer, the polymeric protective layer, or both, are cross-linked.

18. The corrosion-resistant metallized film of any one of claims 1 to 17, wherein the polymeric primer layer, the polymeric protective layer, or both, comprise water-borne polymeric material.

19. The corrosion-resistant metallized film of any one of claims 1 to 18, wherein the polymeric protective layer comprises at least one polymer and at least one silicone wetting agent.

20. The corrosion-resistant metallized film of any one of claims 1 to 19, wherein the metal layer comprises indium, aluminum, tin, stainless steel, copper, silver, gold, chromium, nickel, alloys thereof, or any combination thereof.

21. The corrosion-resistant metallized film of any one of claims 1 to 20, wherein the metal layer has a surface resistivity of at least about 10 ohms/cm².

22. The corrosion-resistant metallized film of any one of claims 1 to 21, further comprising at least one additional layer attached to an outer surface of the polymeric primer layer opposite the first surface, an outer surface of the protective layer opposite the second surface, or both.

23. The corrosion-resistant metallized film of any one of claims 1 to 22, further comprising at least one adhesive layer attached to an outer surface of the polymeric primer layer opposite the first surface or an outer surface of an additional layer attached to an outer surface of the polymeric primer layer opposite the first surface.

24. The corrosion-resistant metallized film of claim 23, wherein the at least one adhesive layer comprises a pressure sensitive adhesive layer.

25. The corrosion-resistant metallized film of any one of claims 1 to 24, further comprising at least one release liner on at least one outermost surface of the corrosion-resistant metallized film.

26. The corrosion-resistant metallized film of claim 25, wherein the at least one release liner provides topographical features to one or both of the outermost surfaces of the corrosion-resistant metallized film.

27. A thermoformable article comprising at least one thermoformable layer and at least one corrosion-resistant metallized film according to any one of claims 1 to 24.

28. A thermoformed article comprising the thermoformable article of claim 27 following a thermoforming step.

29. A method of forming a corrosion-resistant metallized film, said method comprising the steps of:
providing a polymeric protective layer having a first surface with an overall positive or negative surface charge;
depositing a metal layer on the first surface, said depositing step being terminated prior to or shortly after an onset of conductance within the metal layer; and
applying a polymeric primer layer over the metal layer, said polymeric primer layer comprising a second surface in contact with the metal layer, wherein the second surface has an overall surface charge similar to the first surface.

30. The method of claim 29, wherein said depositing step results in a metal layer having a surface resistivity of at least about 10 ohms/cm².

31. The method of claim 29 or 30, further comprising surface treating the first surface of the polymeric protective layer, the second surface of the polymeric primer layer, or both using a corona discharge surface treatment, a flame surface treatment, or a glow discharge surface treatment.

32. The method of any one of claims 29 to 31, wherein both the first surface and the second surface have an overall positive surface charge.

33. The method of any one of claims 29 to 31, wherein both the first surface and the second surface have an overall negative surface charge.

34. The method of any one of claims 29 to 33, further comprising attaching at least one additional layer to an outer surface of the polymeric primer layer opposite the first surface, an outer surface of the protective layer opposite the second surface, or both.

35. The method of any one of claims 29 to 34, further comprising providing topographical features to one or both outermost surfaces of the corrosion-resistant metallized film.

36. The method of any one of claims 29 to 33, further comprising attaching a thermoformable layer to an outer surface of the polymeric primer layer opposite the first surface to form a thermoformable article.

37. The method of claim 36, further comprising thermoforming the thermoformable article.
